(19) United States
(12) Patent Application Publication
(10) Pub. No.: US 2020/0184572 A1
(43) Pub. Date: Jun. 11, 2020

(54) SALARY MANAGEMENT DEVICE, METHOD, AND COMPUTER PROGRAM

(71) Applicant: Masahiro TAKASAKI, Tokyo (JP)

(72) Inventor: Yoshikazu TAKASAKI, Tokyo (JP)

(21) Appl. No.: 16/617,614

(22) PCT Filed: Mar. 29, 2018
(86) PCT No.: PCT/JP2018/013399

§ 371 Date: Nov. 27, 2019

(30) Foreign Application Priority Data
May 30, 2017 (JP) 2017-106122

(51) Int. Cl. G06Q 40/00; G06Q 10/10; G06Q 20/36

(52) U.S. Cl. CPC G06Q 40/125; G06Q 10/1091; G06Q 40/123; G06Q 20/3678; G06Q 20/3674

(57) ABSTRACT

[Problem] To reliably secure labor receivables of a worker, prevent nonpayment or unpaid salary and deductions, as well as reduce costs required for payments and assessments, and to also prevent fraud by clarifying the basis and process for payment of salary and the like.

[Solution] When approval of salary of a worker is received from a salary payer terminal (22), a salary management device (1) refers to virtual account information DB1E and salary information DB (1D) by way of securement processing unit (12), and correlates, from the salary corresponding to labor receivables acquired by the worker, virtual currency equivalent to a net income amount with a virtual account of the worker from a virtual account of a salary payer to thereby secure the net income amount of the worker. The securement processing unit (12) furthermore refers to the virtual account information DB (1E) and the salary information DB (1D), correlates, from the salary corresponding to the labor receivables acquired by the worker, virtual currency equivalent to deductions to the virtual account of the manager from the virtual account of the salary payer, and registers the deductions as scheduled assessment deductions in the virtual account information DB (1E) to thereby secure the deductions of the worker.

### TECHNICAL FIELD

The present invention relates to a technique for securing salary based on a labor receivable of a worker, and managing the secured salary.

### BACKGROUND ART

Recently, in developing countries, banknotes and high-value banknotes that have come to be frequently employed in such instances as tax evasion, bribery, robbery, and money laundering have stopped being issued, and there has been a rapid increase in mobile money that can be used for settlement and remittance in digital currency using a mobile terminal, and mobile banks that can, inter alia, deposit, wire funds, and withdraw money using mobile money.

However, mobile settlements and remittances using a mobile terminal are mostly prepaid advance payments, and are rarely used for postpaid settlements that transact with credit.

Settlements using in-kind cash are completed on the spot, but salary based on business transaction fees and labor receivables is overwhelmingly often not paid immediately to distributors or workers, and distributors and workers must trust that their customers and employers will pay on the settlement date and payday. In such circumstances, the distributor or worker bears the burden of an uncollected transaction price or an unpaid salary.

### PRIOR ART DOCUMENTS

### Patent Documents

[Patent Document 1] Japanese Laid-Open Patent Application No. 2016-110582

[Patent Document 2] Japanese Laid-Open Patent Application No. 2016-126793

### DISCLOSURE OF THE INVENTION

### Problems the Invention is Intended to Solve

In recent years, there has been an increasing demand for a system that can prevent nonpayment or unpaid salary based on the labor receivables of a worker, and deductions such as social insurance, as well as prevent fraud in monetary transactions, but it still cannot be considered that an adequate system has been provided.

In view of the above, it is an object of the present invention to reliably secure the labor receivables of a worker, prevent nonpayment or unpaid salary, and reduce costs required for payments and assessments.

Another object is to prevent fraud by clarifying the basis and process for payment of salary, prices, and the like.

### Means for Solving the Aforementioned Problems

To achieve the object, a salary management device according to one aspect of the present invention is configured to be capable of communicating via a network with a salary payer terminal used by a salary payer, and

that secures, as salary, virtual currency corresponding to a labor receivable of a worker who is to receive payment of salary from the salary payer from the virtual currency held by the salary payer,

the device comprising:

virtual account information storage means for storing information pertaining to virtual accounts in which is deposited virtual currency held by each of a manager who manages salary based on labor receivables, the salary payer, and the worker;

attendance/absence information storage means for storing attendance/absence information of the worker;

salary computation means for computing a salary amount that corresponds to the labor receivables acquired by the worker based on the attendance/absence information;

salary information storage means for storing the salary amount that corresponds to the labor receivables acquired by the worker;

approval request transmission means for transmitting an approval request to the salary payer terminal in relation to the salary;

approval-receiving means for receiving approval from the salary payer terminal in relation to the salary approved by the salary payer;

first securement processing means for referring to the virtual account information storage means and the salary information storage means, and securing a net income amount of the worker by correlating virtual currency equivalent to the net income amount of the worker to the virtual account of the worker from the virtual account of the salary payer, in the salary that corresponds to the labor receivables acquired by the worker; and

second securement processing means for referring to the virtual account information storage means and the salary information storage means, and securing deductions of the worker by correlating virtual currency equivalent to the deductions of the worker to the virtual account of the manager from the virtual account of the salary payer in the salary that corresponds to the labor receivables acquired by the worker, and registering the deductions as scheduled assessment deductions in the virtual account information storage means.

Virtual currency here means, regardless of the name of digital currency and the like, “property value which can be used in relation to unspecified persons for the purpose of paying consideration for the purchase or leasing of goods or the receipt of provision of services and can also be purchased from and sold to unspecified persons acting as counterparties, and which can be transferred by means of an electronic data processing system” or “property value which can be mutually exchanged with what is set forth in preceding item with unspecified persons acting as counterparties, and which can be transferred by means of an electronic data processing system” (legal definition on the Payment Services Act), including bitcoin and the like.

It is possible to have the salary management device, configured so as to be able to communicate via a network with an attendance/absence management device for managing attendance/absence information of the worker, and

further having attendance/absence information receiving means for receiving attendance/absence information of the worker from the attendance/absence management device.

It is possible to have the salary management device, configured so as to be able to communicate via a network with a worker terminal used by a worker who receives payment of a salary from the salary payer, and

further having securement processing request receiving means for receiving, from the worker terminal, a securement processing request for salary in a range of labor receivables held by the worker.

It is also possible to have the salary management device, configured so as to be able to communicate via a network with a store terminal installed in a store where the worker purchases a product, and

further having:

settlement processing request receiving means for receiving, from the store terminal, a settlement processing request of a price of the product purchased by the worker; and

third securement processing means for securing a price of the product by referring to the virtual account information storage means, correlating, to the virtual account of the manager, a portion of the virtual currency correlated to the virtual account of the worker equivalent to the price of the product, and registering said portion as the scheduled payment price.

It is also possible to have the salary management device further having determination processing means for referring to the virtual account information storage means in accordance with the settlement processing request, and determining whether the price of the product can be settled on the basis of the virtual currency correlated to the virtual account of the worker, and wherein

the third securement processing means secures the price of the product by referring to the virtual account information storage means when settlement of the product price is possible, correlates, to the virtual account of the manager, a portion of the virtual currency correlated to the virtual account of the worker equivalent to the price of the product, and registers said portion as the scheduled payment price.

It is also possible to have the salary management device wherein the third securement processing means divides the virtual currency registered as a scheduled payment price into a tax-excluded price and a tax, and registers the divided virtual currency.

It is also possible to have the salary management device, further having first payment processing means for correlating, on a predetermined date, the tax-excluded price of the product from the virtual account of the manager to the virtual account of the store.

It is also possible to have the salary management device, further having second payment processing means for correlating, on a predetermined date, the tax of the product from the virtual account of the manager to the virtual account of the government agency that collects the tax of the product.

It is also possible to have the salary management device, further having third payment processing means for correlating, on a predetermined date, the deductions from the virtual account of the manager to the virtual account of the government agency that collects the deductions.

It is also possible to have the salary management device, configured so as to be able to communicate via a network with a store terminal installed in a store where the worker purchases a product, and an instant settlement terminal for instantly settling a price based on the purchase of the product, and

further having:

instant settlement processing request receiving means for receiving, from the instant settlement terminal, a debit processing request for the price of the product purchased by the worker;

first debit processing means for referring to the virtual account information storage means and debiting virtual currency equivalent to the price of the product from the virtual account of the worker; and

debit processing completion notification transmission means for transmitting, to the instant settlement terminal, notification that debiting of virtual currency equivalent to the price has been completed.

It is also possible to have the salary management device, configured so as to be able to communicate via a network with a card manager terminal installed under a card manager for managing a prepaid card that is held by the worker and that can be used for settlement processing, and a financial institution terminal installed in a financial institution that manages the account of the card manager, and

further having:

remittance request receiving means for receiving, from the card manager terminal which has received a charge request of a predetermined charge amount from the worker to the prepaid card, a remittance request of the predetermined amount;

second debit processing means for referring to the virtual account information storage means and debiting virtual currency equivalent to the predetermined charge amount from the virtual account of the worker;

remittance request transmission means for transmitting, to the financial institution terminal, a request for remittance of virtual currency debited to the account of the card manager; and

transmission processing result transmission means for transmitting, to the card manager terminal, the result of processing remittance of virtual currency equivalent to the predetermined charge amount.

A salary management device according to another aspect of the present invention is further configured to be capable of communicating via a network with a salary payer terminal used by a salary payer, and

that secures, as salary, virtual currency corresponding to a labor receivable of a worker who is to receive payment of salary from the salary payer from the virtual currency held by the salary payer,

the device comprising:

virtual account information storage means for storing information pertaining to virtual accounts in which is deposited virtual currency held by each of a manager who manages salary based on labor receivables, and the salary payer;

attendance/absence information storage means for storing attendance/absence information of the worker;

salary computation means for computing a salary amount that corresponds to the labor receivables acquired by the worker based on the attendance/absence information;

salary information storage means for storing the salary amount that corresponds to the labor receivables acquired by the worker;

approval request transmission means for transmitting an approval request to the salary payer terminal in relation to the salary;

approval-receiving means for receiving approval from the salary payer terminal in relation to the salary approved by the salary payer;

first securement processing means for referring to the virtual account information storage means and the salary information storage means, and securing a net income amount of the worker by correlating virtual currency equivalent to the net income amount of the worker to the virtual account of the manager from the virtual account of the salary payer, in the salary that corresponds to the labor receivables acquired by the worker; and

second securement processing means for referring to the virtual account information storage means and the salary information storage means, and securing deductions of the worker by correlating virtual currency equivalent to the deductions of the worker to the virtual account of the manager from the virtual account of the salary payer in the salary that corresponds to the labor receivables acquired by the worker, and registering the deductions as scheduled assessment deductions in the virtual account information storage means.

It is also possible to have the salary management device, configured so as to be able to communicate via a network with an attendance/absence management device for managing attendance/absence information of the worker, and

further having attendance/absence information receiving means for receiving attendance/absence information of the worker from the attendance/absence management device.

It is also possible to have the salary management device, configured so as to be able to communicate via a network with a worker terminal used by a worker who receives payment of a salary from the salary payer, and

further having securement processing request receiving means for receiving, from the worker terminal, a securement processing request for salary in a range of labor receivables held by the worker.

It is also possible to have the salary management device, further having:

remittance instruction receiving means for receiving a remittance instruction for a predetermined amount of virtual currency from the worker terminal;

remittance processing means for referring to the virtual account information storage means, and correlating the predetermined amount of virtual currency to the virtual account of the worker in the virtual currency correlated as the net income amount of the worker in the virtual account of the worker.

It is also possible to have the salary management device, configured so as to be able to communicate via a network with a store terminal installed in a store where the worker purchases a product, and

further having:

first settlement processing request receiving means for receiving, from the store terminal, a settlement processing request of a price of the product purchased by the worker, the settlement processing request being based on virtual currency correlated to the virtual account of the manager, or the settlement processing request being based on virtual currency correlated to the virtual account of the worker;

third securement processing means for, when the settlement processing request based on the virtual currency correlated to the virtual account of the manager has been received, securing the price of the product by referring to the virtual account information storage means, and registering, as the scheduled payment price, a portion of the virtual currency correlated as the net income amount of the worker equivalent to the price of the product, in the virtual account of the manager; and

fourth securement processing means for, when the settlement processing request based on the virtual currency correlated to the virtual account of the worker has been received, securing the price of the product by referring to the virtual account information storage means, correlating, to the virtual account of the manager, a portion of the virtual currency correlated to the virtual account of the worker equivalent to the price of the product, and registering said portion as the scheduled payment price.

It is also possible to have the salary management device wherein the third securement processing means and the fourth securement processing means divide the virtual currency registered as a scheduled payment price into a tax-excluded price and a scheduled tax assessment, and register the divided virtual currency.

It is also possible to have the salary management device, having:

first determination processing means for referring to the virtual account information storage means in response to a settlement processing request based on virtual currency correlated to the virtual account of the manager, and determining whether the product price can be settled based on virtual currency that is not registered as the scheduled payment price, scheduled assessment deductions, or scheduled tax assessment, in the virtual currency correlated as virtual currency of the worker in the virtual account of the manager; and

second determination processing means for, when a settlement processing request based on virtual currency correlated to the virtual account of the worker has been received, determining whether the product price can be settled based on the virtual currency correlated to the virtual account of the worker,

the third securement processing means for securing the price of the product by referring to the virtual account information storage means when the product price can be settled, and registering, as the scheduled payment price, a portion of the virtual currency correlated as the net income amount of the worker and equivalent to the price of the product, in the virtual account of the manager, and

the fourth securement processing means for securing the price of the product by referring to the virtual account information storage means when the product price can be settled, correlating, to the virtual account of the manager, a portion of the virtual currency correlated to the virtual account of the worker and equivalent to the price of the product, and registering said portion as the scheduled payment price.

It is also possible to have the salary management device, further having first payment processing means for correlating, on a predetermined date, the tax-excluded price of the product from the virtual account of the manager to the virtual account of the store.

It is also possible to have the salary management device, further having second payment processing means for correlating, on a predetermined date, the tax of the product from the virtual account of the manager to the virtual account of the government agency that collects the tax of the product.

It is also possible to have the salary management device, further having third payment processing means for, on a predetermined payment date, paying a salary to the worker by referring to the virtual account information storage means, and correlating to the virtual account of the worker a portion of virtual currency pertaining to the salary corresponding to a labor receivable acquired by the worker, and which is not registered as a scheduled payment price, scheduled assessment deductions, or scheduled tax assessment.

It is also possible to have the salary management device, further having fourth payment processing means for, on a predetermined payment date, correlating the deductions to the virtual account of the government agency that collects the deductions, from the virtual account of the manager.

It is also possible to have the salary management device, configured so as to be able to communicate via a network with a store terminal installed in a store where the worker purchases a product, and an instant settlement terminal for instantly settling a price based on the purchase of the product, and

further having:

instant settlement processing request receiving means for receiving, from the instant settlement terminal, a debit processing request for the price of the product purchased by the worker;

first debit processing means for referring to the virtual account information storage means and debiting virtual currency equivalent to the price of the product from the net income amount of the worker correlated to the virtual account of the manager; and

debit processing completion notification transmission means for transmitting, to the instant settlement terminal, notification that debiting of virtual currency equivalent to the price has been completed.

It is also possible to have the salary management device, configured so as to be able to communicate via a network with a store terminal installed in a store where the worker purchases a product, and an instant settlement terminal for instantly settling a price based on the purchase of the product, and

further having:

instant settlement processing request receiving means for receiving, from the instant settlement terminal, a debit processing request for the price of the product purchased by the worker;

second debit processing means for referring to the virtual account information storage means and debiting virtual currency equivalent to the price of the product from the virtual account of the worker; and

debit processing completion notification transmission means for transmitting, to the instant settlement terminal, notification that debiting of virtual currency equivalent to the price has been completed.

It is also possible to have the salary management device, configured so as to be able to communicate via a network with a card manager terminal installed under a card manager for managing a prepaid card that is held by the worker and that can be used for settlement processing, and a financial institution terminal installed in a financial institution that manages the account of the card manager, and

further having:

remittance request receiving means for receiving, from the card manager terminal which has received a charge request of a predetermined charge amount from the worker to the prepaid card, a remittance request of the predetermined amount;

third debit processing means for referring to the virtual account information storage means and debiting virtual currency equivalent to the predetermined charge amount from the net income amount of the worker correlated to the virtual account of the manager;

remittance request transmission means for transmitting, to the financial institution terminal, a request for remittance of virtual currency debited to the account of the card manager; and

transmission processing result transmission means for transmitting, to the card manager terminal, the result of processing remittance of virtual currency equivalent to the predetermined charge amount.

It is also possible to have the salary management device, configured so as to be able to communicate via a network with a card manager terminal installed under a card manager for managing a prepaid card that is held by the worker and that can be used for settlement processing, and a financial institution terminal installed in a financial institution that manages the account of the card manager, and

further having:

remittance request receiving means for receiving, from the card manager terminal which has received a charge request of a predetermined charge amount from the worker to the prepaid card, a remittance request of the predetermined amount;

fourth debit processing means for referring to the virtual account information storage means and debiting virtual currency equivalent to the predetermined charge amount from the virtual account of the worker;

remittance request transmission means for transmitting, to the financial institution terminal, a request for remittance of virtual currency debited to the account of the card manager; and

transmission processing result transmission means for transmitting, to the card manager terminal, the result of processing remittance of virtual currency equivalent to the predetermined charge amount.

According to another aspect of the present invention, a salary management method for securing, as salary, virtual currency corresponding to a labor receivable of a worker who is to receive payment of salary from a salary payer from virtual currency held by the salary payer,

by means of a computer configured to be capable of communicating via a network with a salary payer terminal used by the salary payer, wherein

the computer has:

virtual account information storage means for storing information pertaining to virtual accounts in which is deposited virtual currency held by each of a manager who manages salary based on labor receivables, the salary payer, and the worker; and

attendance/absence information storage means for storing attendance/absence information of the worker, and

the method executes:

salary computation processing for computing a salary amount that corresponds to the labor receivables acquired by the worker based on the attendance/absence information;

processing for storing the salary amount that corresponds to the labor receivables acquired by the worker in salary information storage means;

approval request transmission processing for transmitting an approval request to the salary payer terminal in relation to the salary;

approval-receiving processing for receiving approval from the salary payer terminal in relation to the salary approved by the salary payer;

first securement processing for referring to the virtual account information storage means and the salary information storage means, and securing a net income amount of the worker by correlating virtual currency equivalent to the net income amount of the worker to the virtual account of the worker from the virtual account of the salary payer, in the salary amount that corresponds to the labor receivables acquired by the worker; and

second securement processing for referring to the virtual account information storage means and the salary information storage means, and securing deductions of the worker by correlating virtual currency equivalent to the deductions of the worker to the virtual account of the manager from the virtual account of the salary payer in the salary that corresponds to the labor receivables acquired by the worker, and registering the deductions as scheduled assessment deductions in the virtual account information storage means.

According to another aspect of the present invention, a computer program for causing a computer configured to be capable of communicating via a network with a salary payer terminal used by a salary payer to function as a salary management device for securing, as salary, virtual currency corresponding to a labor receivable of a worker who is to receive payment of salary from the salary payer from virtual currency held by the salary payer, wherein

the computer has:

virtual account information storage means for storing information pertaining to virtual accounts in which is deposited virtual currency held by each of a manager who manages salary based on labor receivables, the salary payer, and the worker; and

attendance/absence information storage means for storing attendance/absence information of the worker, and

the program causes the computer to execute:

salary computation processing for computing a salary amount that corresponds to the labor receivables acquired by the worker based on the attendance/absence information;

processing for storing the salary amount that corresponds to the labor receivables acquired by the worker in salary information storage means;

approval request transmission processing for transmitting an approval request to the salary payer terminal in relation to the salary;

approval-receiving processing for receiving approval from the salary payer terminal in relation to the salary by the salary payer;

first securement processing for referring to the virtual account information storage means and the salary information storage means, and securing a net income amount of the worker by correlating virtual currency equivalent to the net income amount of the worker to the virtual account of the worker from the virtual account of the salary payer, in the salary that corresponds to the labor receivables acquired by the worker; and

second securement processing for referring to the virtual account information storage means and the salary information storage means, and securing deductions of the worker by correlating virtual currency equivalent to the deductions of the worker to the virtual account of the manager from the virtual account of the salary payer in the salary that corresponds to the labor receivables acquired by the worker, and registering the deductions as scheduled assessment deductions in the virtual account information storage means.

According to another aspect of the present invention, a salary management method for securing, as salary, virtual currency corresponding to a labor receivable of a worker who is to receive payment of salary from a salary payer from virtual currency held by the salary payer,

by means of a computer configured to be capable of communicating via a network with a salary payer terminal used by the salary payer, wherein

the computer has:

virtual account information storage means for storing information pertaining to virtual accounts in which is deposited virtual currency held by each of a manager who manages salary based on labor receivables, and the salary payer; and

attendance/absence information storage means for storing attendance/absence information of the worker,

the method executing:

salary computation processing for computing a salary amount that corresponds to the labor receivables acquired by the worker based on the attendance/absence information;

processing for storing the salary amount that corresponds to the labor receivables acquired by the worker in salary information storage means;

approval request transmission processing for transmitting an approval request to the salary payer terminal in relation to the salary;

approval-receiving processing for receiving approval from the salary payer terminal in relation to the salary approved by the salary payer;

first securement processing for referring to the virtual account information storage means and the salary information storage means, and securing a net income amount of the worker by correlating virtual currency equivalent to the net income amount of the worker to the virtual account of the manager from the virtual account of the salary payer, in the salary that corresponds to the labor receivables acquired by the worker; and

second securement processing for referring to the virtual account information storage means and the salary information storage means, and securing deductions of the worker by correlating virtual currency equivalent to the deductions of the worker to the virtual account of the manager from the virtual account of the salary payer in the salary that corresponds to the labor receivables acquired by the worker, and registering the deductions as scheduled assessment.

According to another aspect of the present invention, a computer program for causing a computer configured to be capable of communicating via a network with a salary payer terminal used by a salary payer to function as a salary management device for securing, as salary, virtual currency corresponding to a labor receivable of a worker who is to receive payment of salary from the salary payer from virtual currency held by the salary payer, wherein

the computer has:

virtual account information storage means for storing information pertaining to virtual accounts in which is deposited virtual currency held by each of a manager who manages salary based on labor receivables, and the salary payer; and

attendance/absence information storage means for storing attendance/absence information of the worker, and

the program causes the computer to execute:

salary computation processing for computing a salary amount that corresponds to the labor receivables acquired by the worker based on the attendance/absence information;

processing for storing the salary amount that corresponds to the labor receivables acquired by the worker in salary information storage means;

approval request transmission processing for transmitting an approval request to the salary payer terminal in relation to the salary;

approval-receiving processing for receiving approval from the salary payer terminal in relation to the salary approved by the salary payer;

first securement processing for referring to the virtual account information storage means and the salary information storage means, and securing a net income amount of the worker by correlating virtual currency equivalent to the net income amount of the worker to the virtual account of the manager from the virtual account of the salary payer, in the salary that corresponds to the labor receivables acquired by the worker; and

second securement processing for referring to the virtual account information storage means and the salary information storage means, and securing deductions of the worker by correlating virtual currency equivalent to the deductions of the worker to the virtual account of the manager from the virtual account of the salary payer in the salary that corresponds to the labor receivables acquired by the worker, and registering the deductions as scheduled assessment deductions.

### Effect of the Invention

According to the present invention, salary based on labor receivables, and deductions are secured, and risks associated with nonpayment of salary to workers and unpaid deductions can be prevented.

Moreover, costs required for payment of salary and the like, and assessments can be reduced.

Furthermore, the basis and process for payment of salary, the payment of prices, and the like are clarified, and fraud is prevented.

### BRIEF DESCRIPTION OF THE DRAWINGS

FIG. 1 is a functional block diagram illustrating the functions provided by the salary management device pertaining to a first embodiment of the present invention;

FIG. 2 is a diagram illustrating an example of the data stored in a salary payer information DB in the salary management device pertaining to the present embodiment;

FIG. 3 is a diagram illustrating an example of the data stored in a worker information DB in the salary management device pertaining to the present embodiment;

FIG. 4 is a diagram illustrating an example of the data stored in a virtual account information DB in the salary management device pertaining to the present embodiment;

FIG. 5 is a diagram illustrating an example of the data stored in an attendance/absence information DB in the salary management device pertaining to the present embodiment;

FIG. 6 is a diagram illustrating an example of the data stored in a salary information DB in the salary management device pertaining to the present embodiment;

FIG. 7 is a sequence diagram illustrating the flow of processing performed by the salary management device pertaining to the present embodiment;

FIG. 8 is a sequence diagram illustrating the flow of processing performed by the salary management device pertaining to the present embodiment;

FIG. 9 is a sequence diagram illustrating the flow of processing performed by the salary management device pertaining to the present embodiment;

FIG. 10 is a diagram illustrating the movement of virtual currency between virtual accounts in the processing performed by the salary management device pertaining to the present embodiment;

FIG. 11 is a functional block diagram illustrating the functions provided by the salary management device pertaining to a second embodiment of the present invention;

FIG. 12 is a diagram illustrating an example of the data stored in a virtual account information DB in the salary management device pertaining to the present embodiment;

FIG. 13 is a sequence diagram illustrating the processing performed flow by the salary management device pertaining to the present embodiment;

FIG. 14 is a sequence diagram illustrating the flow of processing performed by the salary management device pertaining to the present embodiment;

FIG. 15 is a sequence diagram illustrating the flow of processing performed by the salary management device pertaining to the present embodiment;

FIG. 16 is a diagram illustrating the movement of virtual currency between virtual accounts in the processing performed by the salary management device pertaining to the present embodiment;

FIG. 17 is a functional block diagram illustrating the functions provided by the salary management device pertaining to a third embodiment of the present invention;

FIG. 18 is a sequence diagram illustrating the flow of processing performed by the salary management device pertaining to the present embodiment;

FIG. 19 is a functional block diagram illustrating the functions provided by the salary management device pertaining to a fourth embodiment of the present invention;

FIG. 20 is a sequence diagram illustrating the flow of processing performed by the salary management device pertaining to the present embodiment;

FIG. 21 is a functional block diagram illustrating the functions provided by the salary management device pertaining to a fifth embodiment of the present invention;

FIG. 22 is a sequence diagram illustrating the flow of processing performed by the salary management device pertaining to the present embodiment; and

FIG. 23 is a diagram illustrating the movement of virtual currency between virtual accounts in the processing performed by the salary management device pertaining to the present embodiment.

### BEST MODE FOR CARRYING OUT THE INVENTION

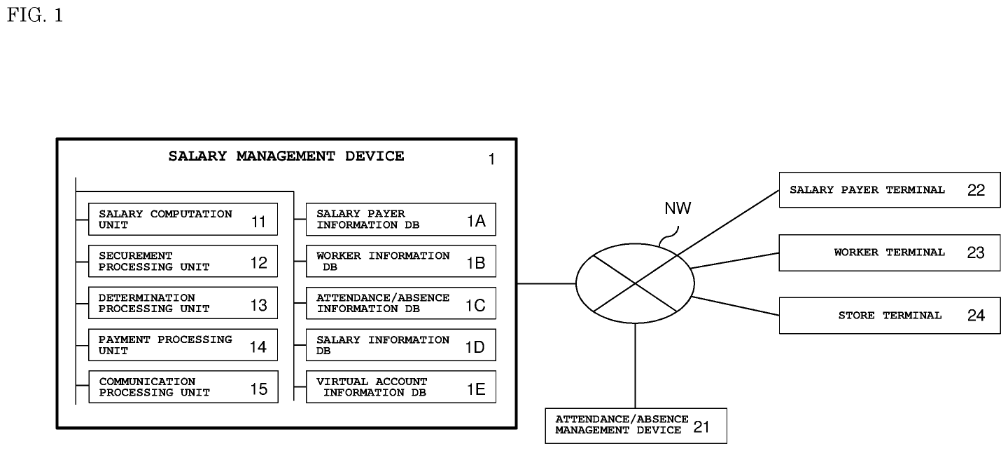

The salary management device 1 pertaining to an embodiment of the present invention is described below with reference to the drawings. FIG. 1 shows the configuration of the salary management device 1 pertaining to the first embodiment of the present invention; The salary management device 1 is managed by a predetermined manager, and is a device for securing, as salary, virtual currency that corresponds to labor receivables of a worker who is to receive payment of salary from a salary payer from the virtual currency held by the salary payer.

This salary management device 1 is configured so as to allow communication, via a network NW such the Internet, between an attendance/absence management device 21 for acquiring attendance/absence information of workers, a salary payer terminal 22 used by a salary payer, a worker terminal 23 used by workers, and a store terminal 24 used by a store.

Moreover, the salary management device 1 is implemented by a so-called server computer or the like using hardware resources such as a central processing unit (CPU), random access memory (RAM), read only memory (ROM), and a hard disk drive, and software resources such as a computer program executed by the CPU, to thereby configure functional blocks comprising a salary computation unit 11, a securement processing unit 12, a determination processing unit 13, a payment processing unit 14, a communication processing unit 15, salary payer information DB1A, worker information DB1B, attendance/absence information DB1C, salary information DB1D, and virtual account information DB1E.

The salary payer information DB1A is a storage unit in which information pertaining to a salary payer is stored.

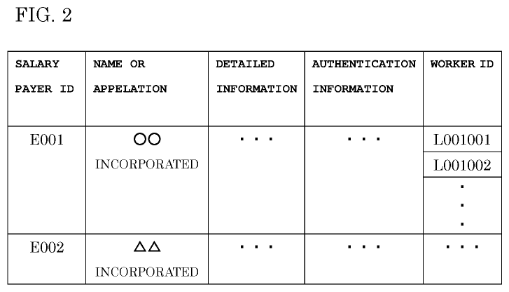

The salary payer information DB1A stores, in a correlated manner, e.g., a name or appellation of a salary payer, address, and other detailed information for each salary payer ID that can identify the salary payer, authorization information for authorizing the salary payer when the salary payer accesses the salary management device 1, and a worker ID of a worker who is a staff member that works to receive salary from the salary payer, as shown in FIG. 2.

The worker information DB1B is a storage unit in which information pertaining to a worker is stored.

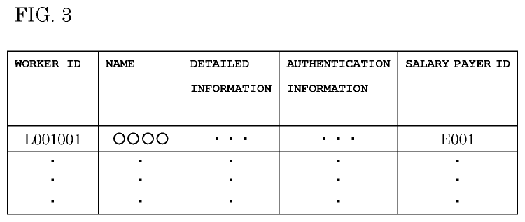

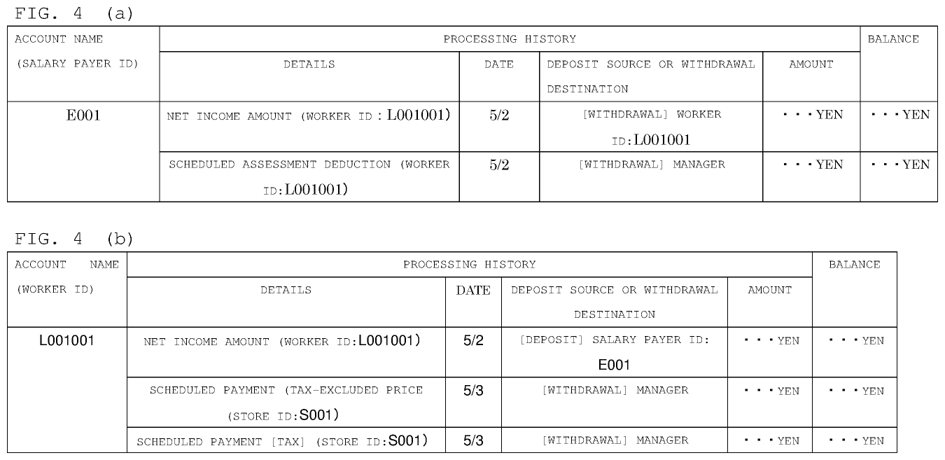

The worker information DB1B contains, e.g., detailed information including the name, address, and other personal information of the worker, authentication information, and the salary payer ID of a salary payer (*1) who is an employer who employs a worker, as shown in FIG. 3.

Authentication information includes information for authenticating a worker when the worker has accessed the salary management device 1 from the worker terminal 23, as well as information for authenticating the worker in a settlement that accompanies a product purchase when the worker has, inter alia, purchased the product in a store on the basis of virtual currency held in the virtual account belonging to the worker.

The virtual account information DB1E is a storage unit in which information pertaining to the virtual accounts of a manager, salary payer, and worker is stored.

Here, the virtual account is a conceptual account in which virtual currency is deposited, and, by correlation with information that identifies a predetermined amount of virtual currency and a predetermined person, said predetermined person is treated as one holding a predetermined amount of virtual currency. Then, by changing the entity correlated to the virtual currency, the entity holding the virtual currency can be changed, that is, virtual currency can be moved between virtual accounts.

Moreover, a net income amount, scheduled assessment deductions, and the type of scheduled payment price (tax excluded) and scheduled payment price (tax) are registered in the virtual currency deposited in or withdrawn from each virtual account. The net income amount is an amount that a worker actually receives after insurance, pension, and various other deductions have been excluded from the worker salary. The scheduled assessment deductions are those scheduled to be assessed as insurance, pension, and other deductions from the worker salary. The scheduled payment price (tax excluded) is money paid to a store when the worker has purchased a produced in a store, and excludes taxes such as consumption tax. The scheduled payment price (tax) is a tax such as a consumption tax received or collected by a government agency when the worker has purchased a produced in a store.

FIG. 4 shows an example of a virtual account managed in the virtual account information DB1E.

FIG. 4(a) shows the virtual account of a salary payer, and the processing history and balance are stored for each salary payer ID indicated in the account name.

The processing history is a deposit/withdrawal history in the virtual account of the salary payer as the account holder, and includes information pertaining to the processing details, date and time, deposit source and withdrawal destination, and the amount. The processing details show are shown together with information about the holder of the processed virtual currency, and the information of the holder of the virtual account of the deposit source or withdrawal destination is indicated in the deposit source and withdrawal destination.

Specifically, in FIG. 4(a), processing in which the content is “net income amount (worker ID: L001001),” the date and time is “5/2”, the deposit/withdrawal destination is “[withdrawal] worker ID: L001001,” and the amount is “ . . . yen [withdrawal]” indicates that, on May 2nd, “ . . . yen” was withdrawn as the net income amount of the worker identified by the worker ID of L001001, and that the deposit was made to the virtual account of the worker identified by the worker ID of L001001. Moreover, processing in which the content is “scheduled assessment deductions (worker ID: L001001),” the date and time is “5/2”, the deposit source or withdrawal destination is “[withdrawal] manager,” and the amount is “ . . . yen” indicates that, on May 2nd, “ . . . yen” was withdrawn as the scheduled assessment deductions of the worker identified by the worker ID identified by L001001, and that the deposit was made to the virtual account of the manager.

FIG. 4(b) shows the virtual account of a worker, and the processing history and balance are stored for each worker ID indicated in the account name.

In the virtual account of the worker as well, the processing history is a deposit/withdrawal history in the virtual account of the salary payer as the account holder, and includes information pertaining to the processing details, date and time, deposit source and withdrawal destination, and the amount. The processing details show are shown together with information about the holder of the processed virtual currency, and the information of the holder of the virtual account of the deposit source or withdrawal destination is indicated in the deposit source and withdrawal destination.

Specifically, in FIG. 4(b), processing in which the content is “net income amount (worker ID: L001001),” the date and time is “5/2”, the deposit source or withdrawal destination is “[deposit] salary payer ID: E001,” and the amount is “ . . . yen” indicates that, on May 2nd, “ . . . yen” was deposited as the net income amount to the virtual account of the worker (worker's own virtual account) identified by the worker ID: L001001.

FIG. 4(c) shows the virtual account of a manager, and the processing history is stored for each salary payer ID of a salary payer or worker ID of a worker, which are entities to be processed.

In the virtual account of the manager as well, the processing history is a deposit/withdrawal history in the virtual account of the salary payer or the worker, which are entities to be processed, and includes information pertaining to the processing details, date and time, deposit source and withdrawal destination, and the amount. The processing details show are shown together with information about the holder of the processed virtual currency, and the information of the holder of the virtual account of the deposit source or withdrawal destination is indicated in the deposit source and withdrawal destination.

Specifically, in FIG. 4(c), processing in which the entity to be processed is “worker ID: L001001,” the content of processing history is “scheduled payment price [tax excluded] (worker ID: L001001),” the date and time is “4/28,” the deposit source or withdrawal destination is “[withdrawal] store ID: S001,” and the amount is “ . . . yen” indicates that, on April 28th, virtual currency of . . . yen secured as scheduled payment price of the worker identified by the worker ID of L001001 was withdrawn to the virtual account of the store identified by the store ID of S001.

Information about a virtual account managed by another manager is registered in the virtual account information DB1E. In other words, when a virtual account of a store, government agency, or the like is managed by another manager, information is registered as requisite for remitting virtual currency from the manager side, such as the account number of the store or government agency.

In the present example, the virtual account of the store or the government agency is managed by another manager, and the case in which only information such as the account number is registered in the virtual account information DB1E is used as an example in relation to the virtual account of the store or the government agency. However, in other embodiments, the salary management device 1 can also manage the virtual account of a store or government agency, and in such embodiments, the same processing as in the present embodiment can be performed.

The virtual currency of the salary payer or worker managed in the virtual account of the manager generates interest depending on the investment method. In view thereof, in other embodiments, the interest generated in relation to the virtual currency of the salary payer and worker managed in the virtual account of the manager may be returned to the salary payer and worker who hold the virtual currency. In this case, interest generated in accordance with the period under the management of the manager is correlated to the virtual account of the salary payer and the worker with reference to information pertaining to the holder of the virtual currency correlated to the virtual account of the manager, whereby the interest can be returned to the salary payer or the worker.

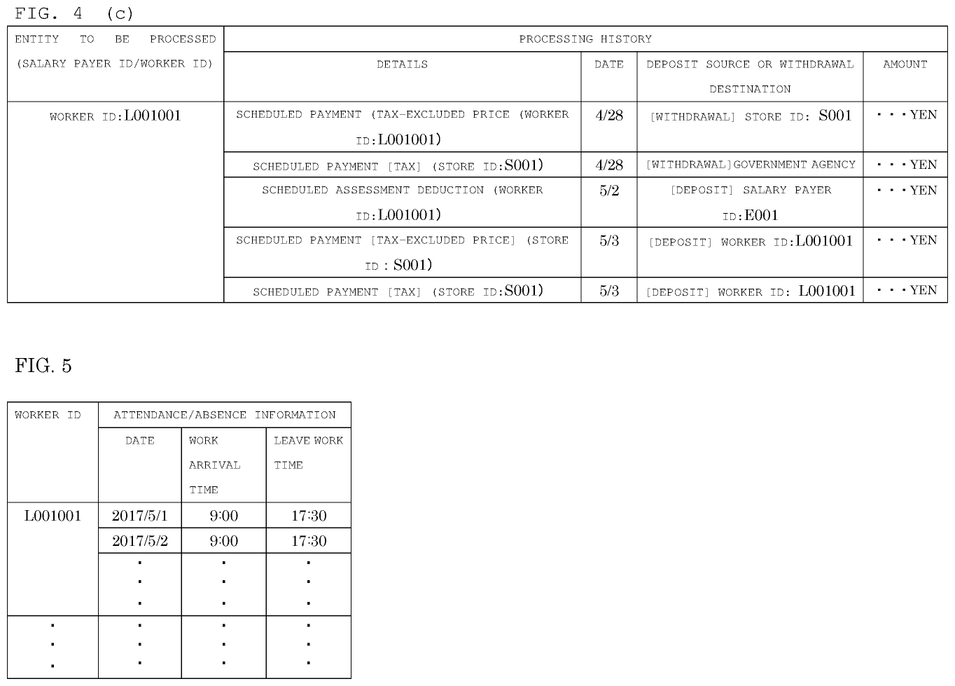

The attendance/absence information DB1C is a storage unit for storing attendance/absence information of the worker. The attendance/absence information is provided by an attendance/absence management device 21, and the worked time of the worker can be ascertained from the attendance/absence information. Information pertaining to the date and time, clock-in time, and clock-out time is correlated with the attendance/absence information DB1C for each worker ID, as shown in FIG. 5.

The salary information DB1D is a storage unit for storing salary information for each worker.

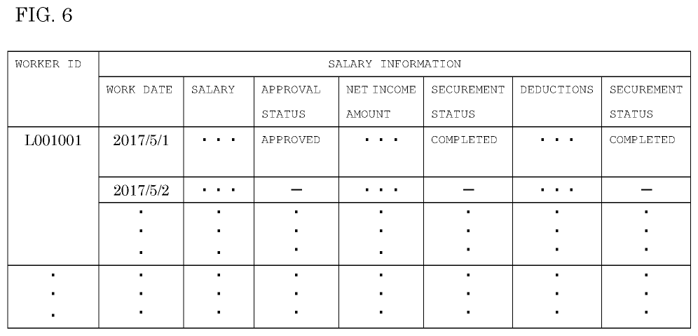

Information pertaining to at-work days, salary amount, approval status, net income amount, payment status of the net income amount, deductions, and payment status of deductions is correlated and stored as salary information for each worker ID in the salary information DB1D, as shown in FIG. 6.

Here, the salary is calculated for each at-work day on the basis of the attendance/absence information.

Approval status is information that indicates whether the salary payer has approved the salary on a predetermined at-work day. Securement status is information that indicates whether the net income amount and deductions have been secured by the worker and the government agency, respectively.

The salary computation unit 11 computes the salary amount that corresponds to the labor receivables acquired by the worker on the basis of the attendance/absence information stored in the attendance/absence information DB1C.

The salary amount for each labor receivable acquired by the worker, as well as the net income amount, deductions, and the like are calculated by the salary computation unit 11.

The securement processing unit 12, as first securement processing, refers to the virtual account information DB1E and the salary information DB1D, correlates, from the salary corresponding to the labor receivables acquired by the worker, virtual currency equivalent to the worker net income amount to the virtual account of the worker from the virtual account of the salary payer, and registers the virtual currency as a predetermined worker net income amount. When the virtual currency is correlated to the virtual account of the worker, ownership of the virtual currency is transferred to the predetermined worker. As a result, regardless of bankruptcy of the salary payer or the ability of the salary payer to pay, the salary based on the labor receivables acquired by the worker thus far is secured for the worker and is reliably provided into the possession of the worker.

The securement processing unit 12, as second securement processing, refers to the virtual account information DB1E and the salary information DB1D, correlates, from the salary corresponding to the labor receivables acquired by a predetermined worker, virtual currency equivalent to worker deductions to the virtual account of the manager from the virtual account of the salary payer, and registers the deductions as scheduled assessment deductions of said predetermined worker. In similar fashion to the net income amount of the worker, when the virtual currency is correlated to the virtual account of the manager, ownership of the virtual currency is transferred to the predetermined worker. As a result, regardless of bankruptcy of the salary payer or the ability of the salary payer to pay, the deductions that should be paid from the salary of the worker are secured for the worker and the deductions can be reliably assessed.

When the worker has, inter alia, purchased a product in a store on the basis of the virtual currency held in the virtual account of the worker, the securement processing unit 12, as third securement processing, refers to the virtual account information DB1E, correlates, to the virtual account of the manager, a portion of the virtual currency correlated to the virtual account of the worker and equivalent to the price of the product, and registers the scheduled payment price to the predetermined store. Here, a tax-excluded price and a tax type are assigned to the scheduled payment price, the tax-excluded price is treated as an expense paid to the store, and the tax is treated as an expense assessed by the government agency.

As a result, regardless of, inter alia, the ability of the worker and store to pay, the price of the product including the tax is secured. Workers can, inter alia, purchase products on the basis of virtual currency secured in accordance with labor receivables, and loans and other money-borrowing do not need to be received for the reason that there is no money at hand until a predetermined salary payment date.

This third securement processing is executed only when the price of the product can be settled when it is determined by a later-described determination processing unit 13 whether the price of the product can be settled.

When the worker has, inter alia, purchased a product in a store on the basis of the virtual currency held in the virtual account belonging to the worker, the determination processing unit 13 refers to the virtual account information DB1E in accordance with a settlement processing request from the store, and determines whether the price of the product can be settled on the basis of the virtual currency correlated to the virtual account of the worker. In other words, it is determined whether the product price and tax can be covered by the amount of the virtual currency correlated to the virtual account of the worker. If the product price and tax can be covered, it is determined that payment is possible, and if the product price and tax cannot be covered, it is determined that settlement is not possible.

The payment processing unit 14, as first payment processing, pays the price of the product purchased by the worker at a store, by correlating the price to the virtual account of the store from the virtual account of the manager on a predetermined date.

The payment processing unit 14, as second payment processing, pays the tax related to the product purchased by the worker at the store, by correlating the tax to the virtual account of the government agency that receives or collects the tax of the product from the virtual account of the manager on a predetermined date.

Furthermore, the payment processing unit 14, as third payment processing, pays deductions of the worker by correlating the deductions to the virtual account of the government agency that receives or collects deductions from the virtual account of the manager on a predetermined date.

The communication processing unit 15 is a functional unit for executing transceiving processing of various data between the attendance/absence management device 21, the salary payer terminal 22, the worker terminal 23, and the store terminal 24 via a network NW.

The attendance/absence management device 21 is a computer for acquiring and tabulating attendance/absence information composed of clock-in and clock-out times of the worker.

The attendance/absence management device 21 receives and tabulates input of attendance/absence information from the worker, and transmits the attendance/absence information to the salary management device 1 configured so as to be capable of communication with the salary management device 1 via the network NW.

The attendance/absence management device 21 may be provided as a dedicated device such as a time recorder, or may be incorporated as software in a staff terminal.

The salary payer terminal 22 is a terminal used by the salary payer or an employer that employs the worker and pays the salary of the worker, and is implemented by a smart device or the like such as a so-called personal computer, tablet terminal, and mobile telephone capable of transceiving data.

The salary payer terminal 22 is provided with communication processing means for executing transceiving processing of various data with the salary management device 1 via the network NW, and input/output means for outputting attendance/absence information of the worker received from the salary management device 1 and inputting approval of the attendance/absence information.

The worker terminal 23 is a terminal used by a worker or staff member who is employed by the salary payer and receives payment of salary from the salary payer, (*2) and is implemented by a smart device or the like such as a so-called personal computer, tablet terminal, and mobile telephone capable of transceiving data.

The worker terminal 23 is provided with communication processing means for executing transceiving processing of various data with the salary management device 1 via the network NW, and input/output means for inputting and outputting various data. These means are capable of transmitting a salary securement processing request to the salary management device 1.

The store terminal 24 is a terminal provided to a store where the worker purchases a product, and is implemented by, inter alia, a smart device such as a so-called personal computer, tablet terminal, and mobile telephone capable of transceiving data.

The store terminal 24 is provided with communication processing means for executing transceiving processing of data with the salary management device 1 via the network NW, and input/output means for inputting and outputting various data. The input/output and transceiving of the data related to the product sale to a worker can be performed by these means. The input/output means includes, e.g., a card reader for acquiring authentication information for authenticating the worker who has purchased a product at the time of settlement in accompaniment with a product sale.

In the description of the salary management device 1 pertaining to the present embodiment, mention has been made of settlement in the case that the worker has purchased a product at a store; however, the phrase “purchase a product” should not be construed narrowly, and may also include provision of services, and is intended for various paid transactions between workers and stores.

The flow performed by the salary management device 1 pertaining to the present embodiment shall now be described.

A salary payer holds a fixed amount of money in advance in a virtual account as virtual currency as a source of salary to be paid to the worker.

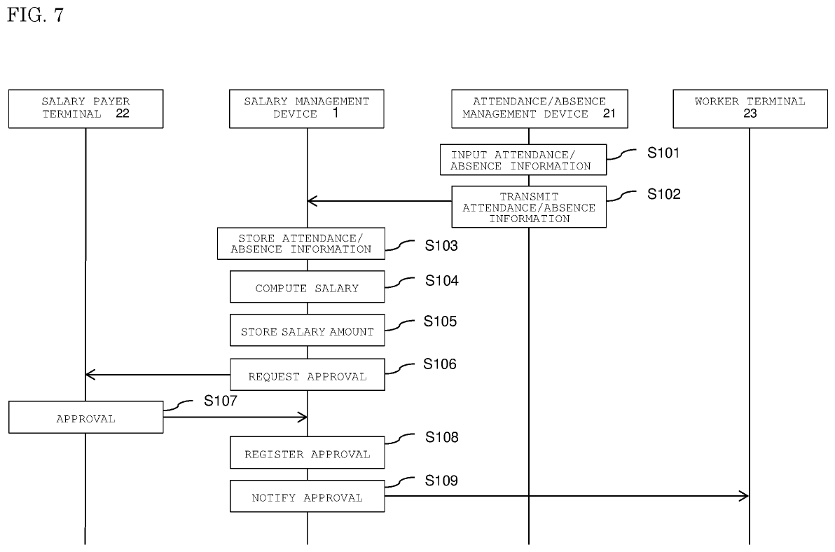

First, the flow that involves collection of attendance/absence information of the worker and ends with the approval of the salary amount based on the attendance/absence information by the salary payer will be described with reference to FIG. 7.

The worker inputs attendance/absence information to the attendance/absence management device 21 in accordance with their duties (S101). The inputted attendance/absence information is transmitted to the salary management device 1 (S102) and stored in the attendance/absence information DB1C (S103).

The salary management device 1 computes (S104), with the aid of the salary computation unit 11, the salary with reference to the attendance/absence information DB1C and stores (S105) the computed salary amount in the salary information DB1D.

When the salary amount has been established, an approval request seeking approval of the salary payer for the salary amount is transmitted from the salary management device 1 to the salary payer terminal 22 (S106).

The salary payer that has received the approval request confirms the salary amount of the worker, and transmits approval to the salary management device 1 if there is no problem (S107).

When approval is received from the salary payer terminal 22, the salary management device 1 registers the approval with reference to the salary information storage unit (S108). The worker is notified of registered approval details, i.e., the approved salary amount, via the worker terminal 23 (S109).

Here, the salary approved by the salary payer can then be secured anytime by the worker as a labor receivable of the worker.

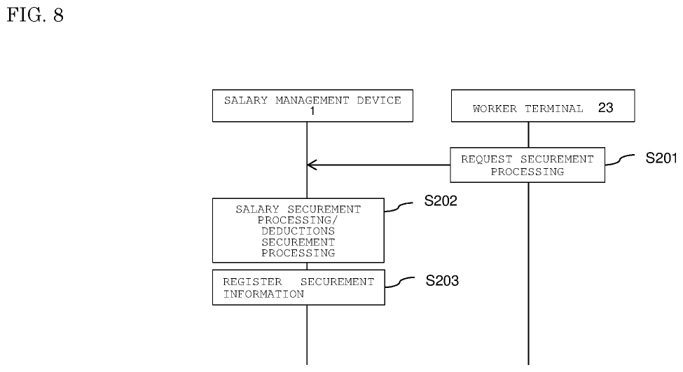

Described next with reference to FIG. 8 is the flow for processing the salary, i.e., the labor receivables approved by the salary payer when the worker has requested the manager to perform securement processing.

Using the worker terminal 23, the worker transmits the securement processing request to the salary management device for predetermined labor receivables held by the worker (S201).

The salary management device 1, which has received the securement processing request from the worker terminal 23, executes processing for securing the net income amount and deductions for the predetermined labor receivables with the aid of the securement processing unit 12 (S202). In other words, the securement processing unit 12 refers to the virtual account information DB1E and the salary information DB1D, correlates, from the salary corresponding to the labor receivables requested by the securement processing, virtual currency equivalent to the worker net income amount to the virtual account of the worker from the virtual account of the salary payer, and registers the virtual currency as the worker net income amount. At the same time, the securement processing unit 12 refers to the virtual account information DB1E and the salary information DB1D, correlates, from the salary corresponding to the labor receivables (*3) requested by securement processing, virtual currency equivalent to worker deductions to the virtual account of the manager from the virtual account of the salary payer, and registers the deductions as scheduled assessment deductions.

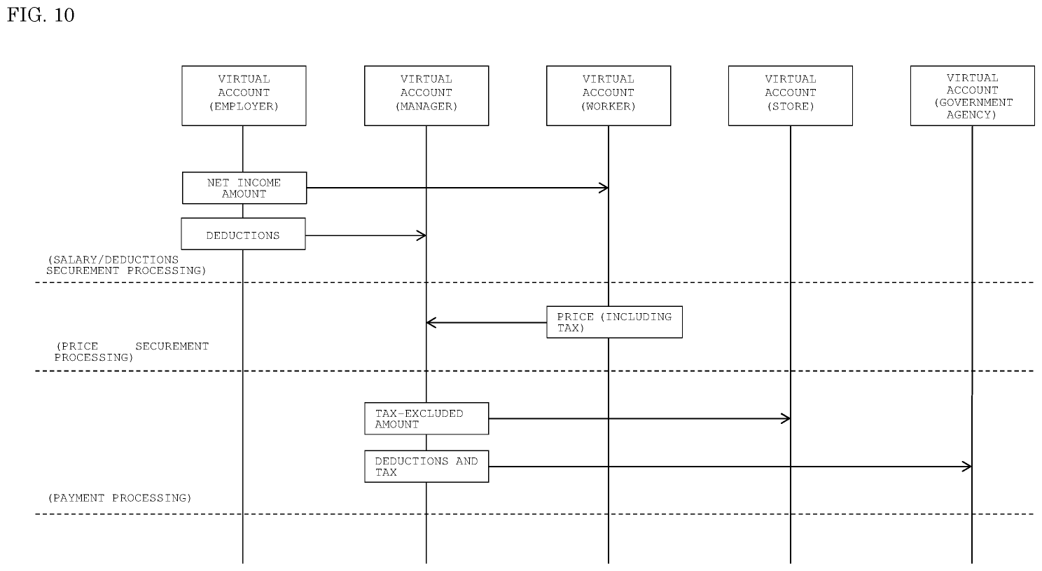

Here, the movement of virtual currency between virtual accounts when salary/deductions securement processing (S202) has been executed will be described with reference to FIG. 10.

The net income amount is correlated to the virtual account of the worker from the virtual account of the employer. The worker can thereby freely use the virtual currency deposited as the net income amount in the virtual account belonging to the worker. The worker can use the virtual currency in its virtual state, or can convert the virtual currency into cash for use as required. The deductions are correlated to the virtual account of the manager from the virtual account of the employer.

When securement processing that includes the net income amount and deductions based on predetermined labor receivables, information indicating that the salary resulting from securement processing has been secured is registered in the salary information DB1D (S203).

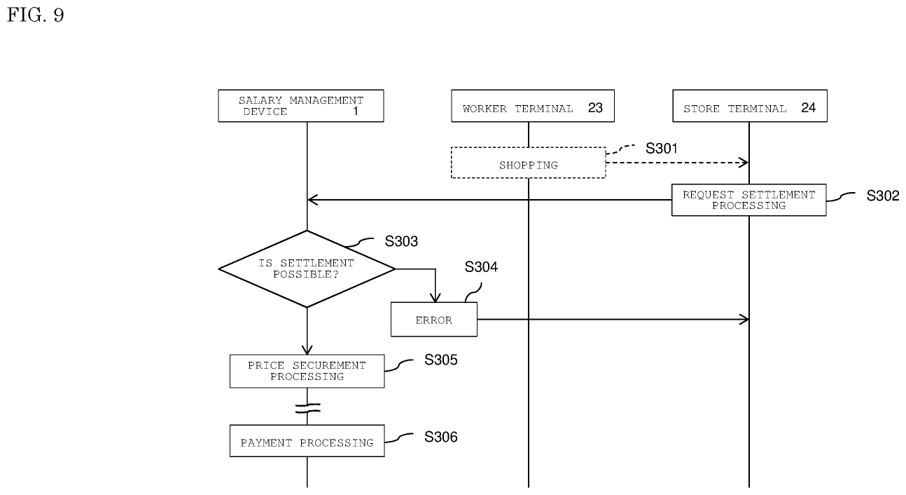

Processing when the worker shops at a store on the basis of virtual currency held in the virtual account belonging to the worker is next described with reference to FIG. 9.

When the worker shops at a store (S301) and requests settlement at the store based on virtual currency held in the virtual account belonging to the worker, the worker transmits a settlement processing request from the store terminal 24 to the salary management device 1 (S302).

Here, in the request for settlement from the worker to the store, authentication information for authenticating the worker is provided by the worker to the store. The authentication information may be saved in an IC chip or other medium.

The settlement processing request from the single store terminal to the salary management device 1 is accompanied by information for identifying and authenticating the worker, store information, and furthermore, information such as the content and price of the product.

The salary management device 1 which has received the settlement processing request from the store terminal 24 determines whether to settle by means of the determination processing unit 13 (S303). In other words, the determination processing unit 13 refers to the virtual account information DB1E, and determines whether the price of the product can be covered by the amount of virtual currency correlated to the virtual account of the worker.

As a result, when it has been determined that settlement is not possible, notification of an error is made to the store terminal 24 (S304).

Meanwhile, when it has been determined that settlement is possible, processing for securing the price accompanying the product purchase is executed by the securement processing unit (S305). In other words, the securement processing unit 12 refers to the virtual account information DB1E, correlates, to the virtual account of the manager, a portion of the virtual currency correlated to the virtual account of the worker and equivalent to the price of the product, and registers the scheduled payment price to the predetermined store. Here, the scheduled payment price is registered having furthermore been divided into a tax-excluded price to be paid to the store registered and a scheduled tax assessment assessed by the government agency.

Here, the movement of virtual currency between virtual accounts when price securement processing (S305) has been executed will be described with reference to FIG. 10.

The price, including the tax-excluded price and the tax, is correlated to the virtual account of the manager from the virtual account of the worker. Consequently, virtual currency corresponding to the price of the product can no longer be freely used by the worker, and there is no possibility that the settlement of the price of the product will not be fulfilled.

When a predetermined date such as the end of the month arrives, payment processing for the price of the product is executed (S306).

In other words, the payment processing unit 14 correlates the tax-excluded price of the product to the virtual account of the store from the virtual account of the manager, and the tax-excluded price of the product to be paid to the store is thereby paid. The payment processing unit 14 correlates the tax generated in accompaniment with the purchase of the product by the worker, to the virtual account of the government agency from the virtual account of the manager, and the tax of the product is thereby paid to the government agency. Furthermore, the payment processing unit 14 correlates the deductions of the worker to the virtual account of the government agency from the virtual account of the manager, and the deductions are thereby paid to the government agency.

Here, the movement of virtual currency between virtual accounts when payment processing (S306) has been executed will be described with reference to FIG. 10.

The tax-excluded price is correlated to the virtual account of the store that sold the product to the worker from the virtual account of the employer. The deductions and the tax generated by the product sale are correlated to the virtual account of the government agency from the virtual account of the manager. Processing for paying the price, tax, and deductions that accompany the sale of a product is thereby completed.

In accordance with the salary management device 1 pertaining to the present embodiment described above, the life activities of workers who work seriously are protected against worker receivables not being paid and deductions not being paid.

Workers can shop based on daily labor receivables, eliminating the need to incur interest-bearing debts until payday.

The system for securing salary and taxes is linked with the personnel, attendance/absence, and salary systems, so that it is instantly determined who will pay, and when, to whom, for what purpose, and how much to pay.

Since payments or the like are made in virtual currency, the origin and transaction process of receivables become clear and fraud can be prevented.

Furthermore, since all payments are made automatically, costs required for paying salaries and collecting taxes can be greatly reduced.

### EXAMPLE 2

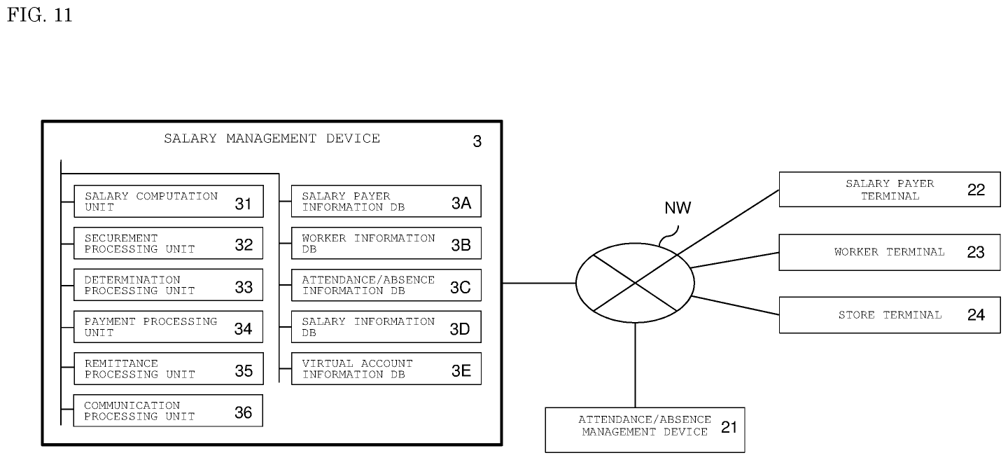

FIG. 11 shows the configuration of the salary management device 3 pertaining to the second embodiment of the present invention.

In the present embodiment, when the net income amount of salary based on the labor receivables acquired by the worker is secured, the amount is registered in the virtual account of the manager as the net income amount of the worker, which is different from the first embodiment.

The salary management device 3 is managed by a predetermined manager, and is a device for securing, as salary, virtual currency that corresponds to labor receivables of a worker who is to receive payment of salary from a salary payer, from the virtual currency held by the salary payer, in the same manner as the salary management device 3 (*4) pertaining to the first embodiment.

This salary management device 3 is configured so as to allow communication, via a network NW such the Internet, between an attendance/absence management device 21 for acquiring attendance/absence information of workers, a salary payer terminal 22 used by a salary payer, a worker terminal 23 used by workers, and a store terminal 24 used by a store.

Moreover, the salary management device 3 is implemented by a so-called server computer or the like using hardware resources such as a central processing unit (CPU), random access memory (RAM), read only memory (ROM), and a hard disk drive, and software resources such as a computer program executed by the CPU, to thereby configure functional blocks comprising a salary computation unit 31, a securement processing unit 32, a determination processing unit 33, a payment processing unit 34, a remittance processing unit 35, a communication processing unit 36, salary payer information DB3A, worker information DB3B, attendance/absence information DB3C, salary information DB3D, and virtual account information DB3E.

The functions of the salary computation unit 31, the communication processing unit 36, the salary payer information DB3A, the worker information DB3B, the attendance/absence information DB3C, and the salary information DB3D are the same as the functions of the salary computation unit 31, the communication processing unit 36, the salary payer information DB3A, worker information DB3B, attendance/absence information DB3C, and salary information DB3D, respectively, in the first embodiment described above.

The virtual account information DB3E is a storage unit in which information pertaining to the virtual accounts of the manager, salary payer, and worker are stored, in the same manner as the first embodiment, but the withdrawal destination of the net income amount from the salary payer, the details of processing in the virtual account of the manager, and other details are different from the first embodiment.

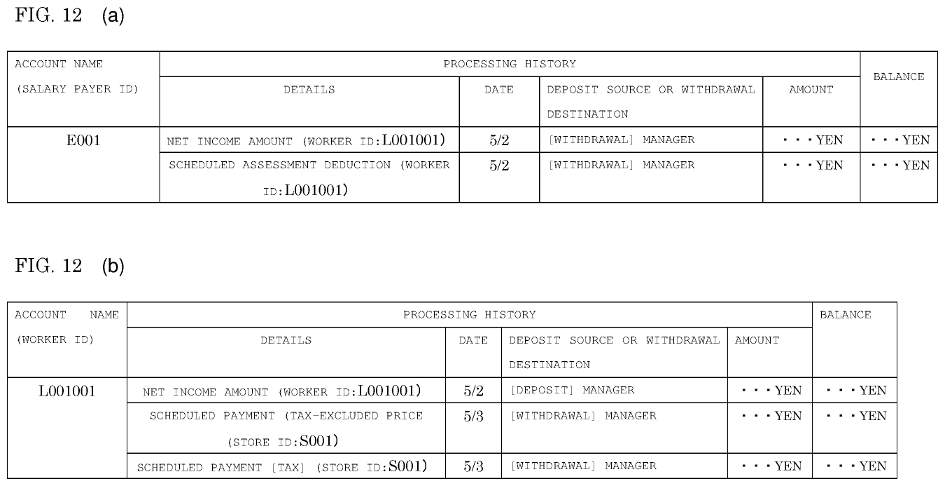

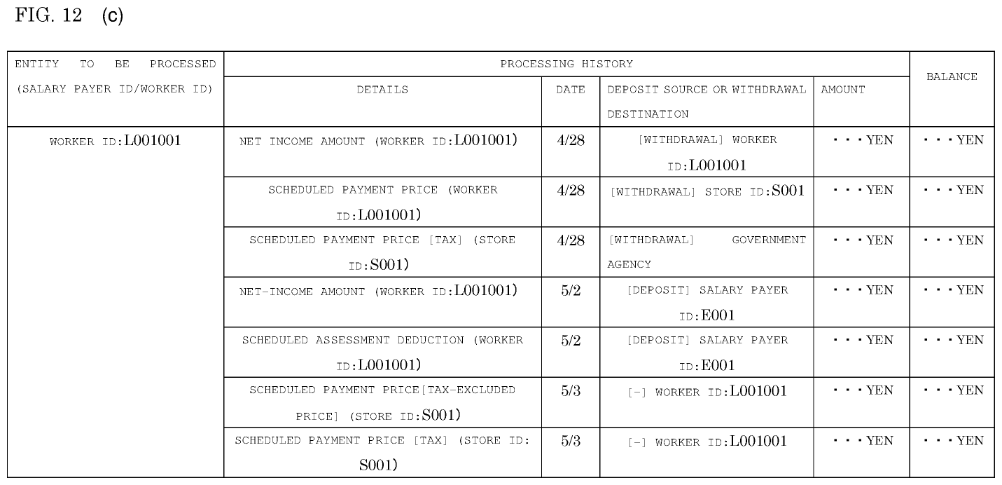

FIG. 12 shows an example of a virtual account managed in the virtual account information DB3E of the present example.

FIG. 12(a) shows the virtual account of a salary payer, and the processing history and balance are stored for each salary payer ID indicated in the account name.

In the present example, the net income amount of the worker may move from the virtual account of the salary payer to the virtual account of the manager in the processing history.

Specifically, in FIG. 12(a), processing in which the content is “net income amount (worker ID: L001001),” the date and time is “5/2”, and the deposit/withdrawal destination is “[withdrawal] manager,” and the amount is “ . . . yen [withdrawal]” indicates that, on May 2nd, “ . . . yen” was withdrawn as the net income amount of the worker identified by the worker ID of L001001, and that the deposit was made to the virtual account of the manager.

FIG. 12(b) shows the virtual account of a worker, and the processing history and balance are stored for each worker ID indicated in the account name.

In the present example, the net income amount of the worker may move from the virtual account of the manager to the virtual account of the worker in the processing history.

Specifically, in FIG. 12(b), processing in which the content is “net income amount (worker ID: L001001),” the date and time is “5/2”, the deposit source or withdrawal destination is “[deposit] manager,” and the amount is “ . . . yen” indicates that, on May 2nd, “ . . . yen” was deposited as the net income amount from the manager to the virtual account of the worker (worker's own virtual account) identified by the worker ID: L001001.

FIG. 12(c) shows the virtual account of a manager, and in the present example, the processing history is stored for each salary payer ID of a salary payer or worker ID of a worker, which are entities subject to processing. Also stored is information pertaining to the balance of virtual currency managed as virtual currency of each entity subject to processing.

In the present example, the net income amount (*5) of the worker may move from the virtual account of the manager to the virtual account of the worker in the processing history. The net income amount of the worker held in the virtual account of the manager may be registered as a scheduled payment price when the worker has purchased a product at a store.

Specifically, in FIG. 12(c), processing in which the entity to be processed is “worker ID: L001001,” the content of processing history is “net income amount (worker ID: L001001),” the date and time is “4/28”, the deposit source or withdrawal destination is “[deposit] worker ID: L001001,” and the amount is “ . . . yen” indicates that, on April 28th, “ . . . yen” was deposited as the net income amount from the manager to the virtual account of the worker identified by L001001. Moreover, the entity to be processed is “worker ID: L001001,” the content of processing history is “scheduled payment price [tax excluded] (store ID: S001),” the date and time is “5/3,” the deposit source or withdrawal destination is “-,” and the amount is “ . . . yen” indicates that, on May 3rd, . . . yen of the amount managed by the manager as the net income amount of the worker is registered as a scheduled payment price (tax excluded) of the store identified by the store ID of S001.

Information about a virtual account managed by another manager is registered in the virtual account information DB3E, in the same manner as in the first embodiment. In other words, when a virtual account of a store, government agency, or the like is managed by another manager, information is registered as requisite for remitting virtual currency from the manager side, such as the account number of the store or government agency.

In the present example, the virtual account of the store or the government agency is managed by another manager, and the case in which only information such as the account number is registered in the virtual account information DB3E is used as an example in relation to the virtual account of the store or the government agency. However, in other embodiments, the salary management device 3 can also manage the virtual account of a store or government agency, and in such embodiments, the same processing as in the present embodiment can be performed.

Moreover, interest is generated depending on how the virtual currency of the salary payer and worker managed by the virtual account of the manager is invested. In view thereof, in other embodiments, the interest generated for the virtual currency of the salary payer and worker managed by the virtual account of the manager may be returned to the salary payer and worker who hold the virtual currency. In this case, interest generated in accordance with the period under the management of the manager is correlated to the virtual account of the salary payer and the worker with reference to information pertaining to the holder of the virtual currency correlated to the virtual account of the manager, whereby the interest can be returned to the salary payer or the worker. In relation to the net income amount of the worker being managed by the manager in the virtual account of the manager, interest generated until the net income amount moves to the virtual account of the worker may be returned to the salary payer of the worker. In this case, the interest calculated based on the balance of the net income amount of the worker can be correlated to the virtual account of the salary payer of the worker.

The securement processing unit 32, as first securement processing, refers to the virtual account information DB3E and the salary information DB3D, correlates, from the salary corresponding to the labor receivables acquired by a predetermined worker, virtual currency equivalent to the worker net income amount to the virtual account of the manager from the virtual account of the salary payer, and registers the virtual currency as a predetermined worker net income amount. When the virtual currency is correlated to the virtual account of the manager, ownership of the virtual currency is transferred to the predetermined worker. As a result, regardless of bankruptcy of the salary payer or the ability of the salary payer to pay, the salary based on the labor receivables acquired by the worker thus far is secured for the worker and is reliably provided into the possession of the worker.

The securement processing unit 32, as second securement processing, refers to the virtual account information DB3E and the salary information DB3D, correlates, from the salary corresponding to the labor receivables acquired by the worker, virtual currency equivalent to worker deductions to the virtual account of the manager from the virtual account of the salary payer, and registers the deductions as scheduled assessment deductions. In similar fashion to the net income amount of the worker, when the virtual currency is correlated to the virtual account of the manager, ownership of the virtual currency is transferred to the predetermined worker. As a result, regardless of bankruptcy of the salary payer or the ability of the salary payer to pay, the deductions that should be paid from the salary of the worker are secured for the worker and the deductions can be reliably assessed.

When the worker has purchased a product in a store and has requested settlement based on the virtual currency of the worker correlated to the virtual account of the manager, the securement processing unit 32, as third securement processing, refers to the virtual account information DB3E, and registers, as a scheduled payment price, a portion of the virtual currency correlated with net income amount of the worker and equivalent to the price of the product, to the virtual account of the manager.

Meanwhile, when the worker has purchased a product in a store and has requested settlement based on virtual currency correlated to the virtual account of the worker, the securement processing unit 32, as fourth securement processing, refers to the virtual account information DB3E, correlates, to the virtual account of the manager, a portion of the virtual currency correlated to the virtual account of the worker and equivalent to the price of the product, and registers the scheduled payment price.

Here, in the third securement processing and fourth securement processing, a tax-excluded price and a tax type are assigned to the scheduled payment price, the tax-excluded price is treated as an expense paid to the store, and the tax is treated as an expense assessed by the government agency.

As a result, regardless of, inter alia, the ability of the worker and store to pay, the price of the product including the tax is secured. Workers can, inter alia, purchase products on the basis of virtual currency secured in accordance with labor receivables, and loans and other money-borrowing are not required for the reason that there is no money at hand until a predetermined salary payment date.

This third securement processing and fourth securement processing are executed only when the price of the product can be settled when it is determined by a later-described determination processing unit 33 whether the price of the product can be settled.

When the worker has purchased a product in a store and has requested settlement based on the virtual currency of the worker correlated to the virtual account of the manager, the determination processing unit 33, as first determination processing, refers to the virtual account information DB3E in response to a settlement processing request from the store, and determines whether the product price can be settled based on virtual currency that is not registered as the scheduled payment price, scheduled assessment deductions, or scheduled tax assessment, in the virtual currency (*6) correlated as virtual currency of the worker in the virtual account of the manager. In other words, it is determined whether the product price and tax can be covered by the amount of virtual currency for which no purpose has been determined and that can be freely used by the worker from the virtual currency of the worker correlated to the virtual account of the manager. If such can be covered, it is determined that payment is possible, and if such cannot be covered, it is determined that settlement is not possible.

On the other hand, when the worker has purchased a product in a store and has requested settlement based on the virtual currency correlated to the virtual account of the worker, second determination processing refers to the virtual account information DB3E in response to a settlement processing request from the store, and determines whether the product price can be settled based on the virtual currency correlated to the virtual account of the worker. In other words, it is determined whether the product price and tax can be covered by the amount of the virtual currency correlated to the virtual account of the worker. If such can be covered, it is determined that payment is possible, and if such cannot be covered, it is determined that settlement is not possible.

The payment processing unit 34, as first payment processing, pays the tax-excluded price of the product purchased by the worker at a store, by correlating the price to the virtual account of the store from the virtual account of the manager on a predetermined date.

The payment processing unit 34, as second payment processing, pays the tax related to the product purchased by the worker at the store, by correlating the tax to the virtual account of the government agency from the virtual account of the manager on a predetermined date.

The payment processing unit 34, as third payment processing, refers to the virtual account information DB3E on a predetermined date, and pays a salary to the worker by correlating to the virtual account of the worker a portion of virtual currency pertaining to the salary that corresponds to the labor receivables acquired by the worker that is not registered as the scheduled payment price, scheduled assessment deductions, or scheduled tax assessment.

Furthermore, the payment processing unit 34, as fourth payment processing, refers to the virtual account information DB3E on a predetermined date, and pays deductions of the worker by correlating the deductions of the worker to the virtual account of the government agency from the virtual account of the manager.

When a remittance instruction for a predetermined amount of virtual currency has been received from the worker terminal 23, the remittance processing unit 35 refers to the virtual account information DB3E, and executes processing that correlates a predetermined amount of virtual currency in the virtual account of the manager to the virtual account of the worker from the virtual currency correlated as a net income amount of the worker.

In the remittance processing, the virtual currency that can be correlated to the virtual account of the worker is limited to that which is not registered as a scheduled payment price, scheduled assessment deductions, or scheduled tax assessment.

Described next is the flow of processing by the salary management device 3 pertaining to the present embodiment.

A salary payer holds a fixed amount of money in advance in a virtual account as virtual currency as a source of salary to be paid to the worker.

First, attendance/absence information of the worker is collected, and the salary amount based on the attendance/absence information is approved by the salary payer in the same manner as described with reference to FIG. 7 in relation to the first embodiment described above.

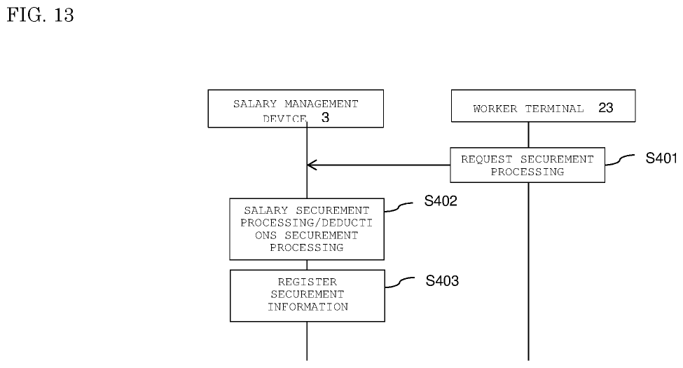

Described next with reference to FIG. 13 is the flow for processing the salary approved by the salary payer when the worker has requested the manager to perform securement processing.

Using the worker terminal 23, the worker transmits the securement processing request to the salary management device for predetermined labor receivables held by the worker (S401).

The salary management device 3, which has received the securement processing request from the worker terminal 23, executes processing for securing the net income amount and deductions for the predetermined labor receivables with the aid of the securement processing unit 32 (S402). In other words, the securement processing unit 32 refers to the virtual account information DB3E and the salary information DB3D, correlates, from the salary corresponding to the labor receivables requested by the securement processing, virtual currency equivalent to the worker net income amount to the virtual account of the manager from the virtual account of the salary payer, and registers the virtual currency as the worker net income amount.

At the same time, the securement processing unit 32 refers to the virtual account information DB3E and the salary information DB3D, correlates, from the salary corresponding to the labor receivables requested by securement processing, virtual currency equivalent to worker deductions to the virtual account of the manager from the virtual account of the salary payer, and registers the deductions as scheduled assessment deductions of the worker.

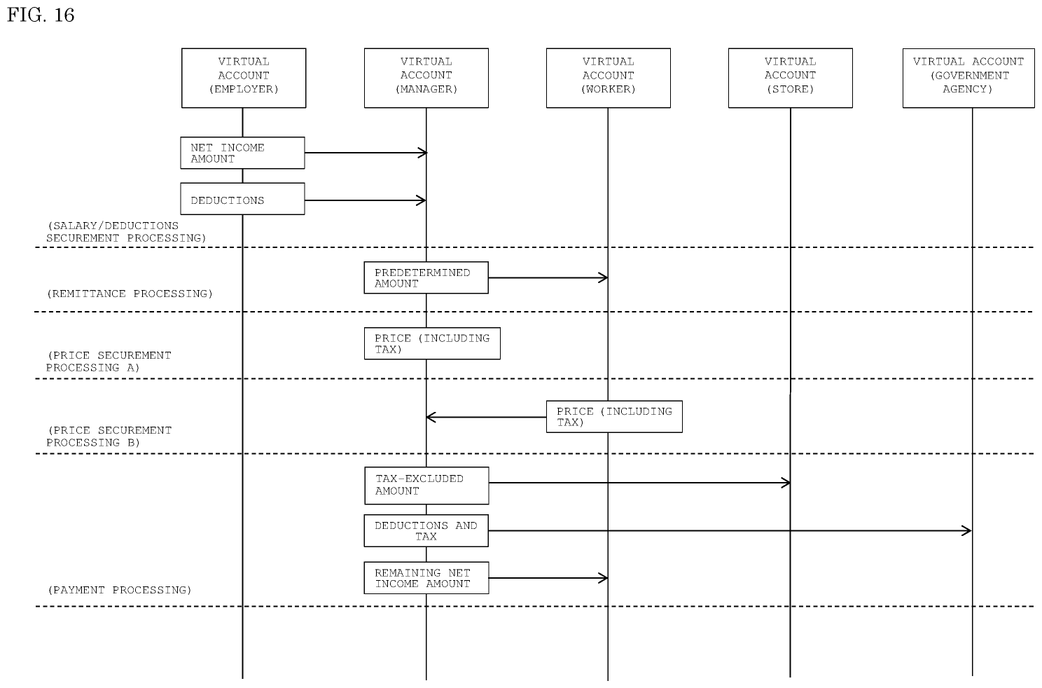

Here, the movement of virtual currency between virtual accounts when salary/deductions securement processing (S402) has been executed will be described with reference to FIG. 16.

The net income amount is correlated to the virtual account of the manager from the virtual account of the employer. The worker thereby also has deductions correlated to the virtual account of the manager from the virtual account of the employer. Salary that corresponds to the labor receivables of the worker is thereby secured.

When securement processing that includes the net income amount and deductions based on predetermined labor receivables, information indicating that the salary resulting from securement processing has been secured is registered in the payroll information DB3D (S403).

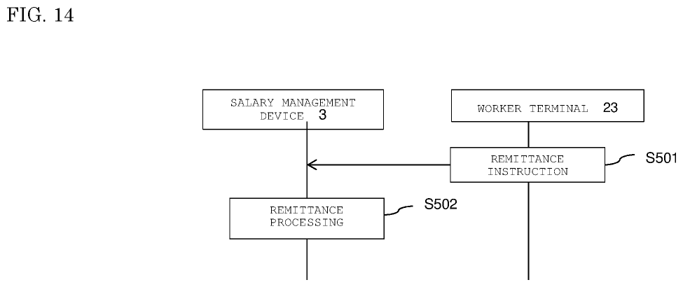

Next, the processing for remitting virtual currency of the worker secured in the virtual account of the manager to the virtual account of the worker in response to a request by the worker will be described with reference to FIG. 14. Using the worker terminal 23, the worker transmits a remittance instruction for requesting that a predetermined amount of the worker's own virtual currency secured in the virtual account of the manager be remitted to the virtual account belonging to the worker (S501).

The amount of virtual currency for which the worker can request remittance is limited to an amount range which is not registered as a scheduled payment price, scheduled assessment deductions, or scheduled tax assessment in the virtual currency correlated to the salary of the worker in the account of the manager.

In response thereto, with the aid of the remittance processing unit 35, the salary management device 3 refers to the virtual account information DB3E and executes processing that correlates the indicated predetermined amount of virtual currency in the virtual account of the manager to the virtual account of the worker from the virtual currency correlated as the net income amount of the worker in the virtual account of the manager (S502).

Here, the movement of virtual currency between virtual accounts when remittance processing (S502) has been executed will be described with reference to FIG. 16.

A predetermined amount of virtual currency indicated by the worker is correlated to the virtual account of the worker from the virtual account of the manager. The worker can thereby freely use the virtual currency deposited as the net income amount in the virtual account belonging to the worker. The worker can use the virtual currency in its virtual state, or can convert the virtual currency into cash for use as required.

Virtual currency registered as a scheduled payment price, scheduled assessment deductions, and scheduled assessed tax does not move to the virtual account of the worker and remains correlated to the virtual account of the manager.

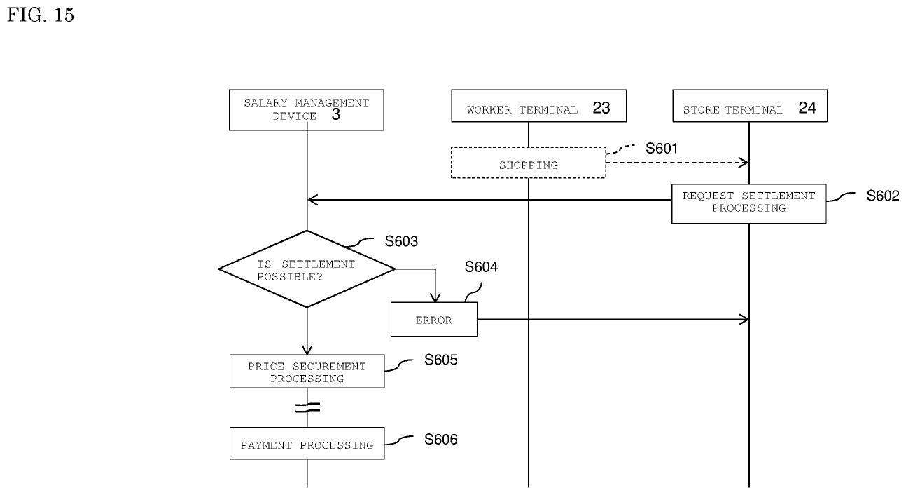

Processing when the worker shops at a store on the basis of the worker's own virtual currency held in the account of the manager or virtual currency held in the virtual account belonging to the worker is next described with reference to FIG. 15.

When the worker shops at a store (S601), the worker indicates the method for settling with the store, that is, settlement based on the worker's own virtual currency correlated to the virtual account of the manager, or settlement based on the virtual currency held in the virtual account belonging to the worker. In response thereto, the store transmits a settlement processing request based on the settlement method indicated by the worker to the salary management device 3 by means of the store terminal 24 (S602).

Here, in the request for settlement from the worker to the store, authentication information for authenticating the worker is provided by the worker to the store in the same manner as the first embodiment. The authentication information may be saved in an IC chip or other medium.

The settlement processing request from the single store terminal to the salary management device 3 is accompanied by information for identifying and authenticating the worker, store information, and furthermore, information such as the content and price of the product in the same manner as in the first embodiment.

The salary management device 3 which has received the settlement processing request from the store terminal 24 determines, by means of the determination processing unit 33, whether settlement is possible (S603). In other words, when settlement based on the virtual currency of the worker correlated to the virtual account of the manager has been indicated, the determination processing unit 33 refers to the virtual account information DB3E, and determines whether the product price can be settled based on virtual currency that is not registered as a scheduled payment price, scheduled assessment deductions, or scheduled assessed tax, in the virtual currency correlated as virtual currency of the worker in the virtual account of the manager. On the other hand, when settlement based on virtual currency correlated to the virtual account of the worker has been indicated, the determination processing unit 33 refers to the virtual account information DB3E and determines whether the product price can be settled based on the virtual currency correlated to the virtual account of the worker.

As a result, when it has been determined that settlement is not possible, notification of an error is made to the store terminal 24 (S604).

On the other hand, when it has been determined that settlement is possible, processing for securing the price accompanying the product purchase is executed by the securement processing unit 32 (S605). In other words, when settlement based on the virtual currency of the worker correlated to the virtual account of the manager has been indicated, the securement processing unit 32 refers to the virtual account information DB3E, and registers, as a scheduled payment price, a portion of the virtual currency correlated with net income amount of the worker and equivalent to the price of the product, to the virtual account of the manager. On the other hand, when settlement based on virtual currency correlated to the virtual account of the worker has been indicated, the securement processing unit 32 refers to the virtual account information DB3E, correlates, to the virtual account of the manager, a portion of the virtual currency correlated to the virtual account of the worker equivalent to the price of the product, and registers the scheduled payment price. Here, the scheduled payment price is registered having furthermore been divided into a tax-excluded price to be paid to the store registered and a scheduled tax assessment assessed by the government agency.

Here, the movement of virtual currency between virtual accounts when price securement processing (S605) has been executed will be described with reference to FIG. 16.

When settlement based on the virtual currency of the worker correlated to the virtual account of the manager has been indicated (price securement processing A in FIG. 16), virtual currency does not move between virtual accounts, and there is only registration of the portion of the virtual currency correlated to the virtual account of the manager as a scheduled payment. On the other hand, when settlement based on virtual currency correlated to the virtual account of the worker has been indicated (price securement processing B in FIG. 16), the price is correlated to the virtual account of the manager from the virtual account of the worker. Consequently, virtual currency corresponding to the price of the product cannot be freely used by the worker, and there is no possibility that the settlement of the price of the product will not be fulfilled.

When a predetermined date such as the end of the month arrives, payment processing for the price of the product and the remaining net income amount of the worker is executed (S606). In other words, the payment processing unit 34 pays the tax-excluded price of the product purchased by the worker at a store, by correlating the price to the virtual account of the store from the virtual account of the manager on a predetermined date. The payment processing unit 34 pays the tax related to the product purchased by the worker at the store, by correlating the tax to the virtual account of the government agency from the virtual account of the manager. Furthermore, the payment processing unit 34 pays a salary to the worker by correlating to the virtual account of the worker a portion of virtual currency pertaining to the salary that corresponds to the labor receivables acquired by the worker that is not registered as the scheduled payment price, scheduled assessment deductions, or scheduled tax assessment.

Here, the movement of virtual currency between virtual accounts when payment processing (S606) has been executed will be described with reference to FIG. 16. The tax-excluded price is correlated to the virtual account of the store that sold the product to the worker from the virtual account of the employer. The deductions and the tax generated by the product sale are correlated to the virtual account of the government agency from the virtual account of the manager. Furthermore, the portion of the virtual currency pertaining to the salary corresponding to the labor receivables acquired by the worker that is not registered as a scheduled payment price, scheduled assessment deductions, or scheduled tax assessment, in other words, the remaining net income amount remaining in the virtual account of the manager that has been secured by the manager and has not been remitted to the virtual account of the worker is correlated to the virtual account of the worker. Processing for paying the price, tax, and deductions that accompany the sale or purchase of a product, and paying the remaining net income amount (*7) of the worker is thereby completed.

In accordance with the salary management device 3 pertaining to the present embodiment above, the net income amount of the worker is secured in the virtual account of the manager, and nonpayment or unpaid salary and deductions based on the labor receivables of the worker is prevented.

### EXAMPLE 3

A salary management device 4 pertaining to a third embodiment in which other settlement processing is applied to a product purchase at a store by a worker will be described in relation to the salary management devices 1, 3 pertaining to the first and second embodiments of the present invention described above.

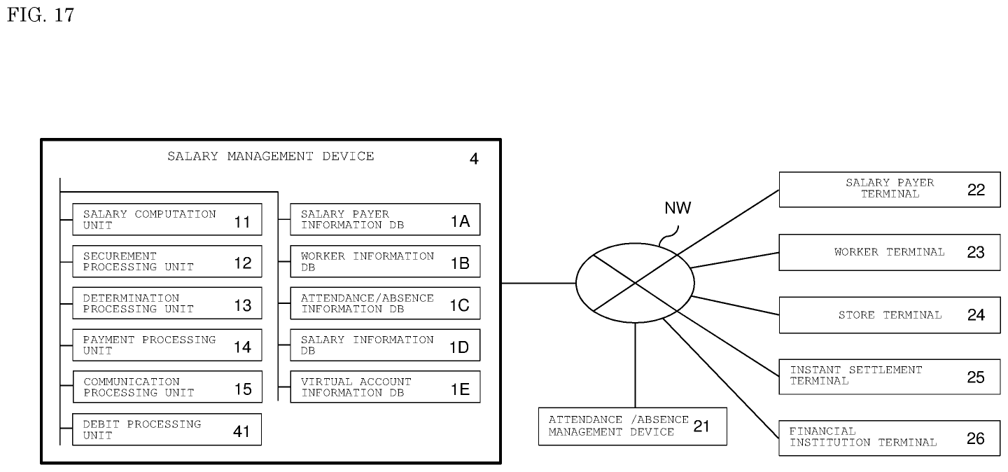

FIG. 17 shows the device configuration of the salary management device 4 pertaining to the present embodiment in which settlement (instant settlement) by means of an existing debit card is possible in relation to the salary management device 1 pertaining to the first embodiment.

In this example, the salary management device 4 is configured to allow communication, via a network NW such the Internet, between an instant settlement terminal 25 and a financial institution terminal 26, in addition to the above-described attendance/absence management device 21, salary payer terminal 22, worker terminal 23, and store terminal 26.

Moreover, the salary management device 4 pertaining to the present embodiment is implemented by a so-called server computer or the like using hardware resources such as a central processing unit (CPU), random access memory (RAM), read only memory (ROM), and a hard disk drive, and software resources such as a computer program executed by the CPU, to thereby configure functional blocks comprising a salary computation unit 11, a securement processing unit 12, a determination processing unit 13, a payment processing unit 14, a communication processing unit 15, salary payer information DB1A, worker information DB1B, attendance/absence information DB1C, salary information DB1D, and virtual account information DB1E, in the same manner as the salary management device 4 (*8) pertaining to the first embodiment, and is also provided with a debit processing unit 41.

When an instant settlement processing request for instant settlement of a product price purchased by a worker has been received, the debit processing unit 41 refers to the virtual account information DB1E and debits virtual currency equivalent to the price of the product from the virtual account of the worker.

When a request for processing has been made from the instant settlement terminal 25 to debit a predetermined price from the virtual account of the worker, the determination processing unit 13 in the present embodiment determines whether to debit the predetermined (*9) price on the basis of the virtual currency in the virtual account of the worker.

The instant settlement terminal 25 is installed under an intermediary that mediates instant settlement processing by a debit card, and is implemented by a so-called server computer or the like. The instant settlement terminal 25 executes debiting of a price in the salary management device 4 in response to a request from a store terminal 24 when the worker has purchased a product at the store, and causes the financial institution to deposit the price to the store.

The financial institution terminal 26 is installed under a financial institution that manages the account of the store, and is implemented by a so-called server computer or the like.

The financial institution terminal 26 executes processing for depositing the predetermined price in the account of the store in response to the request from the instant settlement terminal 25.

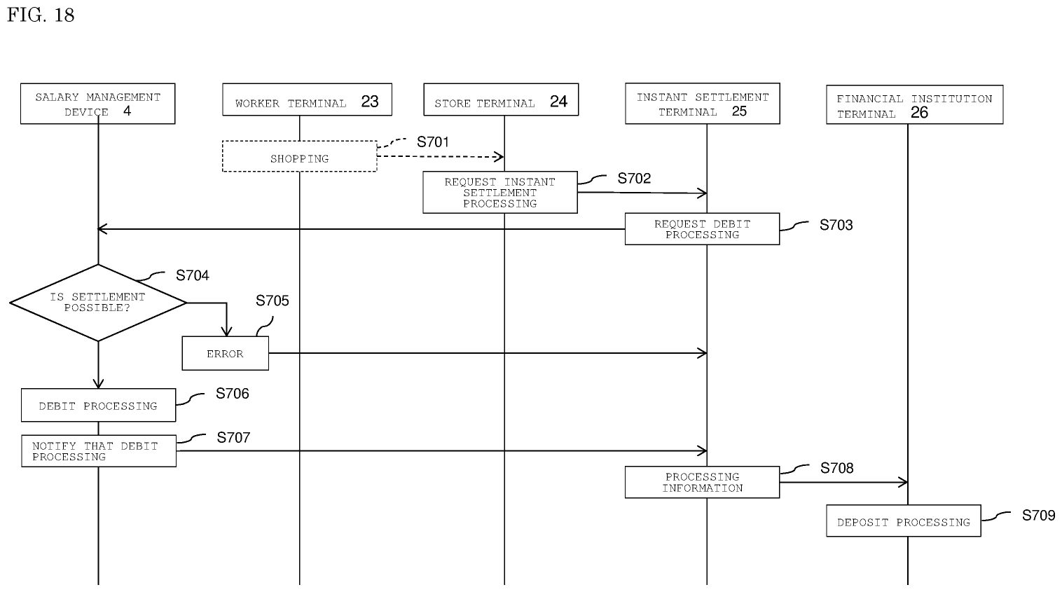

Next, processing by the salary management device 4 pertaining to an embodiment of the present invention will be described with reference to the FIG. 18.

Processing by the salary management device 4 pertaining to the present embodiment is a characteristic of settlements that accompany shopping by the worker, and only that feature will be described. Other features are the same as the examples described above.

When the worker shops at a store (S701) and requests instant settlement with the store based on virtual currency held in the virtual account belonging to the worker, the worker transmits at processing request for instant settlement from the store terminal 24 to the instant settlement terminal 25 (S702).

A debit card that allows use of instant settlement based on virtual currency held in a virtual account is used when a processing request for instant settlement is made. The debit card holds, by means of an IC chip or the like, information for identifying a worker and information such as the access destination to the salary management device 4.

In response thereto, the instant settlement terminal 25 transmits to the salary management device 4 a processing (*10) request for debiting the price of a product purchased by the worker (S703). The debit processing request is accompanied by information for identifying and authenticating the worker, store information, and furthermore, information such as the content and price of the product.

The salary management device 4 which has received the debit processing request from the store terminal 24 determines whether to debit by means of the determination processing unit (S704). In other words, the determination processing unit refers to the virtual account information DB, and determines whether the price of the product can be covered by the amount of virtual currency correlated to the virtual account of the worker.

As a result, when it has been determined that debit is not possible, notification of an error is made to the instant settlement terminal 25 (S705).

On the other hand, when it has been determined that debit is possible, the debit processing unit 41 refers to the virtual account information DB, and the price accompanying the product purchase is debited from the virtual account of the worker (S706).

When debiting has been completed, notification that debiting of virtual currency equivalent to the price has been completed is transmitted from the salary management device 4 to the instant settlement terminal 25 (S707).

In response thereto, the instant settlement terminal 25 transmits to the financial institution terminal 26, as processing information, indication that the debit processing has been completed, information about the store, and information or the like pertaining to the price to be deposited to the store (S708).

The financial institution terminal 26 deposits a predetermined price in the account of the store on the basis of the processing information (S709). Instant settlement processing is thereby completed on the basis of the virtual currency in the virtual account of the worker.

In accordance with the present example, instant settlement processing, which is already widespread, can be used by API interlinking with an existing debit card system. As a result, instant settlement processing, which is already widespread, can be used by labor receivables.

In the present embodiment above, the case in which the instant settlement processing is applied to the salary management device 1 pertaining to the first embodiment, but application can also be made to the salary management device 3 pertaining to the second embodiment as well.

Here, in the first embodiment, the net income amount of the worker is in the virtual account of the worker, and in the second embodiment, the net income amount of the worker is not only in the virtual account of the worker, but is also in the virtual account of the manager. Inasmuch, when the above-described instant settlement processing is applied to the salary management device 3 pertaining to the second embodiment, debiting the price can also be carried out from the virtual account of the worker or the net income amount of the worker managed in the virtual account of the manager. The option to be performed may be alternatively set in advance, or may be selected by a worker.

The total amount of the virtual currency in the virtual account of the worker or the net income amount of the worker managed in the virtual account of the manager is deemed to be an amount that allows instant settlement processing, and the determination processing unit can determine whether debiting a price is possible on the basis of the total amount. When debiting a price is possible using the total amount, the debit processing unit 41 debits the required price from the virtual account of the worker and the virtual account of the manager, and the totaled debit amount is the price. In accordance with such processing, it is convenient for the worker because instant settlement can be used regardless of whether the virtual currency of the worker is in the account of the worker or the manager.

### EXAMPLE 4

A salary management device 5 pertaining to a fourth embodiment in which virtual currency of the worker is charged to a prepaid card held by the worker will be described in relation to the salary management devices 1, 3 pertaining to the first and second embodiments of the present invention described above.

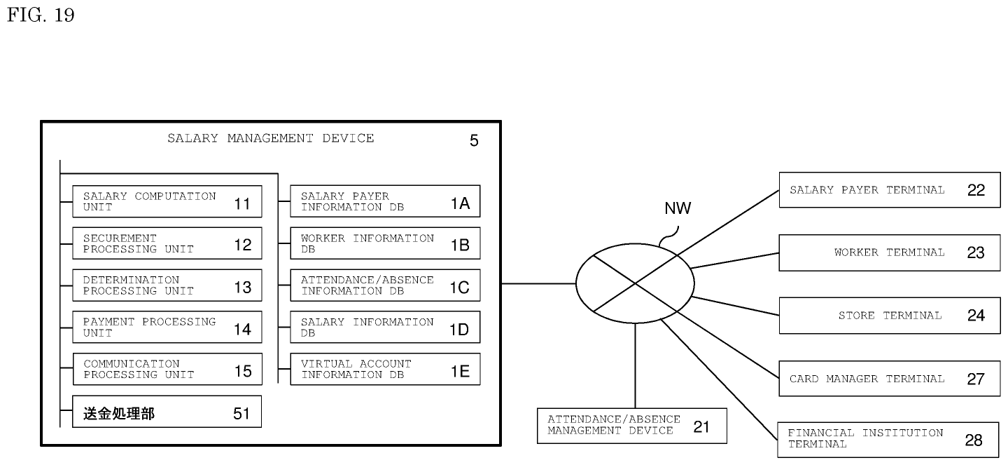

FIG. 19 shows the device configuration of the salary management device 5 pertaining to the present embodiment in which a charge to a prepaid card is possible, in relation to the salary management device 1 pertaining to the first embodiment.

In this example, the salary management device 5 is configured to allow communication, via a network NW such the Internet, between a card manager terminal 27 and the financial institution terminal 28, in addition to the above-described attendance/absence management device 21, salary payer terminal 22, worker terminal 23, and store terminal 24.

The salary management device 5 pertaining to the present embodiment is implemented by a so-called server computer or the like using hardware resources such as a central processing unit (CPU), random access memory (RAM), read only memory (ROM), and a hard disk drive, and software resources such as a computer program executed by the CPU, to thereby configure functional blocks comprising a salary computation unit 11, a securement processing unit 12, a determination processing unit 13, a payment processing unit 14, a communication processing unit 15, salary payer information DB1A, worker information DB1B, attendance/absence information DB1C, salary information DB1D, and virtual account information DB1E, in the same manner as the salary management device 1 pertaining to the first embodiment, and is also provided with a remittance processing unit 51.

When a request for remitting a predetermined amount for a charge to a prepaid card held by the worker has been received from the card manager terminal 27, the remittance processing unit 51 refers to the virtual account information DB and executes processing for debiting virtual currency equivalent to a predetermined charge amount from the virtual account of the worker.

When a request for remitting a predetermined amount has been received from the card manager terminal 27, the determination processing unit 13 in the present embodiment determines whether to debit the predetermined (*11) amount of virtual currency on the basis of the virtual currency in the virtual account of the worker.

The card manager terminal 27 is installed under the card manager who manages the prepaid card, and is implemented by a so-called server computer or the like.

The card manager terminal 27 receives a charge request from the worker for a predetermined charge amount to a prepaid card, and in response thereto, requests a deposit of virtual currency equivalent to the predetermined charge amount to the salary management device 5.

The financial institution terminal 28 is installed under a financial institution that manages the account of the card manager, and is implemented by a so-called server computer or the like.

The financial institution terminal 28 receives, from the manager, a deposit to the account of the card manager for the virtual currency equivalent to the predetermined charge amount, and performs deposit processing. Deposit from the manager to the financial institution may be a conversion of virtual currency into cash.

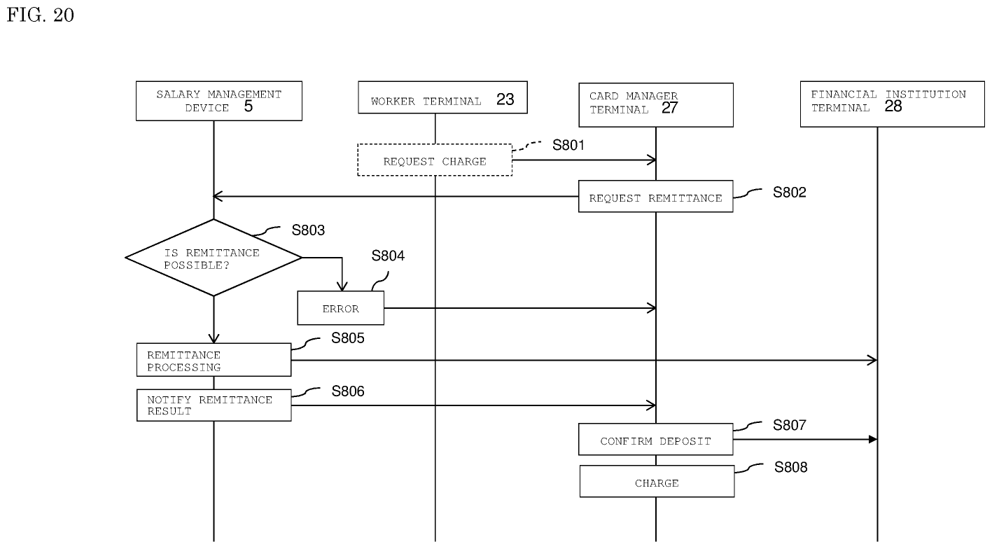

Next, processing by the salary management device 5 pertaining to an embodiment of the present invention will be described with reference to the FIG. 20.

Processing by the salary management device 5 pertaining to the present embodiment is a characteristic for charging prepaid cards, and only that feature will be described. Other features are the same as the examples described above.

First, when the worker requests the card manager to charge a predetermined amount to the prepaid card (S801), a request for remittance of the predetermined amount is transmitted from the card manager terminal 27 to the salary management device 5 (S802). The remittance processing request is accompanied by information for identifying and authenticating the worker, card manager information, information pertaining to the predetermined charge amount, and information relating to the account of the card manager, which is the remittance destination.

The salary management device 5 which has received the remittance request from the card manager terminal 27 determines whether to remit by means of the determination processing unit 13 (S803). In other words, the determination processing unit 13 refers to the virtual account information DB1E, and determines whether amount of virtual currency correlated to the virtual account of the worker.

As a result, when it has been determined that remittance is not possible, notification of an error is made to the card manager terminal 27 (S804).

On the other hand, when it has been determined that remittance is possible, the remittance processing unit 51 refers to the virtual account information DB1E, and virtual currency equivalent to the specified charge amount is debited from the virtual account of the worker, and the debited virtual currency is remitted to the account of the card manager under the management of the financial institution (S805).

When remittance has been completed, notification of the result of remittance indicating that remittance of virtual currency equivalent to the predetermined charge amount has been completed is transmitted from the salary management device 5 to the card manager terminal 27 (S806).

The remittance may be performed using virtual currency, and may be performed after being converted into cash.

In response thereto, the card manager terminal 27 accesses the d28 and confirms the deposit as processing information (S807), and charges the predetermined charge amount to the prepaid card of the worker (S808). When the remittance result notification is received from the salary management device 5, the prepaid card can be charged.

Processing for charging to a prepaid card thereby completed on the basis of the virtual currency in the virtual account of the worker.

In accordance with the present example, it is possible to use a prepaid card, which is already widespread, by API interlinking with an existing prepaid card system. As a result, it is possible to charge to a prepaid card, which is already widespread, on the basis of labor receivables.

In the present embodiment above, the case in which the instant settlement processing is applied to the salary management device 1 pertaining to the first embodiment, but application can also be made to the salary management device 3 pertaining to the second embodiment as well.

Here, in the first embodiment, the net income amount of the worker is in the virtual account of the worker, and in the second embodiment, the net income amount of the worker is not only in the virtual account of the worker, but is also in the virtual account of the manager. Inasmuch, when the above-described charge processing to a prepaid card is applied to the salary management device 3 pertaining to the second embodiment, remittance of virtual currency equivalent to the charge amount can also be carried out from the virtual account of the worker or the net income amount of the worker managed in the virtual account of the manager. The option to be performed may be alternatively set in advance, or may be selected by a worker.

The total amount of the virtual currency in the virtual account of the worker or the net income amount of the worker managed in the virtual account of the manager is deemed to be an amount that allows a charge to a prepaid card, and the determination processing unit 13 can determine whether remittance of virtual currency equivalent to the charge amount is possible on the basis of the total amount. When remittance of virtual currency is possible using the total amount, the remittance processing unit 51 debits the required price from the virtual account of the worker and the virtual account of the manager, and the totaled debit amount is the charge amount. In accordance with such processing, the worker can charge to a prepaid card regardless of whether the virtual currency of the worker is in the account of the worker or the manager.

### EXAMPLE 5

Next, a billing management device 6 in which the salary management devices 1, 3 pertaining to the first and second embodiments of the present invention described above are applied to billing/payment processing in a transaction between companies.

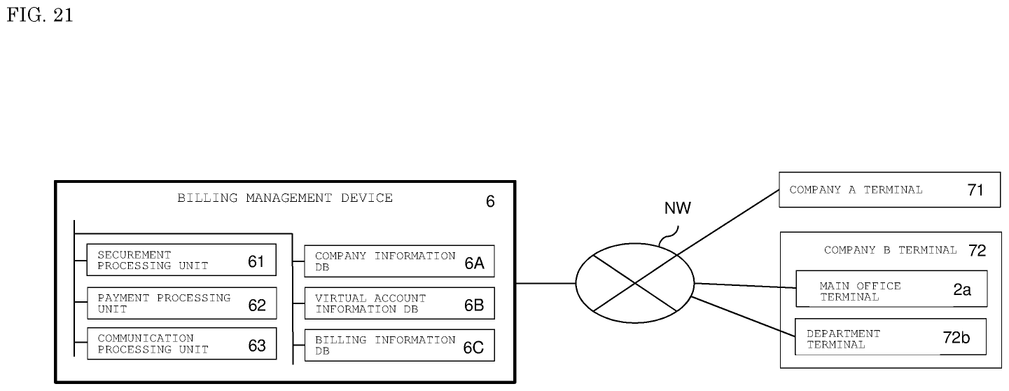

FIG. 21 shows the device configuration of the billing management device 6 pertaining to the present embodiment.

The billing management device 6 manages billing and payment in a transaction between companies, and is managed by a predetermined manager.

The billing management device 6 is configured so as to allow communication, via a network NW such the Internet, between a company A terminal 71 installed under a company A and a company B terminal 72 installed under a company B. In the example in FIG. 21, only the two terminals of the company A terminal 71 and the company B terminal 72, but the number is not particularly limited.

Moreover, the billing management device 6 is implemented by a so-called server computer or the like using hardware resources such as a central processing unit (CPU), random access memory (RAM), read only memory (ROM), and a hard disk drive, and software resources such as a computer program executed by the CPU, to thereby configure functional blocks comprising company information DB6A, virtual account information DB6B, billing information DB6C, a securement processing unit 61, payment processing unit 62, and a communication processing unit 63.

In the description of the present embodiment, only a minimum configuration example based on functions necessary for the billing/payment processing executed by the billing management apparatus 6 is shown, and other functional units described in the first to fourth embodiments can be incorporated, as appropriate.

The company information DB6A is a storage unit in which information pertaining to a company that performs billing and payment is stored. Detailed information including the company name, address, and the like, and authentication information are stored in association with each company ID that can identify the company are stored in this company information DB6A.

Moreover, information on items such as departments, groups, and teams in the company that are independent entities in billing or payment and that have a unique virtual account is stored in the company information. In other words, in the present embodiment, even within a single company, it is possible to have a virtual account for each department or group, and information relating to the department or group is registered in the company information DB6A.

The virtual account information DB6B is a storage unit in which information pertaining to the virtual account of a company is stored.

Here, the virtual account is a conceptual account in which virtual currency is deposited, and, by correlation with information that identifies a predetermined amount of virtual currency and a predetermined person, said predetermined person is treated as one holding a predetermined amount of virtual currency, in the same manner as the first embodiment described above. Then, by changing the entity correlated to the virtual currency, the entity holding the virtual currency can be changed, that is, virtual currency can be moved between virtual accounts.

In this embodiment, a virtual account can be provided in the name of not only a company unit, but also in the name of a department or group unit in the company, and a virtual account provided, as appropriate, is stored in the virtual account information DB6B. A plurality of virtual accounts can be prepared for each purpose and account item.

Deposit/withdrawal history and balance are stored for each name in a virtual account managed in the virtual account information DB6B. The deposit/withdrawal history includes information pertaining to processing details, date and time, deposit source and withdrawal destination, and the amount.

The billing information DB6C is a storage unit in which information pertaining to billing information of a company is stored.

Billing information is information pertaining to billing a price from one entity to another, and includes information such as billing source, billing destination, billing content, billing amount, billing date, and the like. The billing information is registered for each billing unit in correlation with the approval or non-approval of the billing destination, and when the billing destination approves the billing information, information indicating that the request has been approved is registered.

When billing from one of the companies A or B has been made to the other with a predetermined price, or the like, and the other approves the billing, the securement processing unit 61 refers to the virtual account information DB6B, and secures the billing by correlating the virtual currency corresponding to the price or the like pertaining from the billing destination to the billing source.

Here, when tax is included in the billed amount, the billed amount with tax excluded is correlated to the virtual account of the billing source, while the tax is correlated to the manager's virtual account as a scheduled tax assessment by the billing source.

The payment processing unit 62 pays the tax on the predetermined date by correlating the tax included in the billing to the virtual account of the government agency that collects the tax from the virtual account of the manager.

The communication processing unit 63 is a functional unit for executing transceiving processing of various data between the company A terminal 71 and the company B terminal 72 via a network NW.

The company A terminal 71 and the company B terminal 72 are terminals installed at companies that conduct transactions, and are implemented by a computer or the like having input/output means for inputting and outputting data and communication processing means for transceiving data.

The present example shows the case in which the company A has a virtual account only for company A as a unit, and transactions are carried out between the company A and the company B and the like. Also shown is the case in which there is a virtual account for the main office terminal 72a installed in the main office of the company B and each department terminal 72b installed in predetermined departments in the company B, and transactions are carried out for the company A building and main office, and each department.

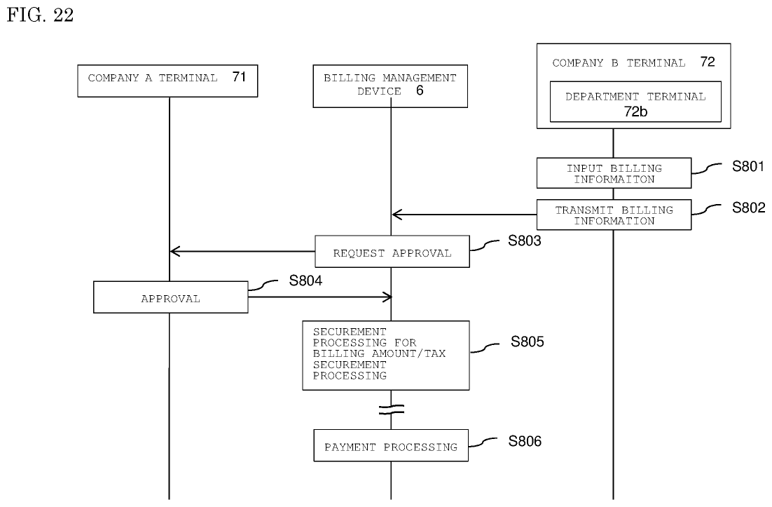

Next, with reference to FIG. 22, the flow of processing when a predetermined department of company B is charged to company A based on a predetermined transaction will be described.

A predetermined department in the company inputs billing information based on the transaction using the department terminal 72b (S801), and transmits the billing information to the billing management apparatus 6 (S802).

The billing management apparatus 6, which has received the billing information from the department terminal 72b of company B, transmits an approval request for the billing information to the company A terminal 71 together with the billing information (S803).

The company A confirms the billing information received from the billing management device 6 by means of the company A terminal 71, and if there is no problem, transmits an approval of the billing information to the billing management device 6 (S804).

In response thereto, the billing management device 6 executes processing for securing the billing based on the billing information by means of the securement processing unit 61. In other words, the securement processing unit 61 refers to the virtual account information DB6B, correlates, from the approved billing, virtual currency equivalent to tax-excluded amount to the virtual account of the predetermined department of company B from the virtual account of company A, and registers the virtual currency as the virtual currency of the predetermined department. At the same time, the securement processing unit 61 refers to the virtual account information DB6B, correlates, from the approved billing, virtual currency equivalent the tax to the virtual account of the manager from the virtual account of company A, and registers the tax as scheduled tax assessment.

When a predetermined date such as the end of the month arrives, processing for paying the tax is executed (S806).

In other words, the payment processing unit 62 correlates the tax included in the billing to the virtual account of the government agency from the virtual account of the manager, and the tax is thereby paid to the government agency.

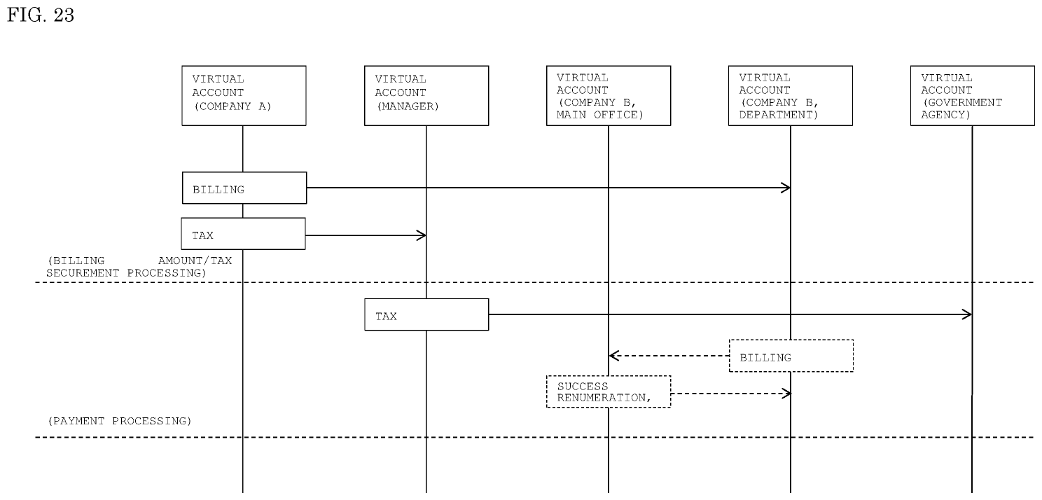

Here, the movement of virtual currency between virtual accounts when securement processing for the billing amount, securement processing for the tax (S805), and payment processing (S806) has been executed will be described with reference to FIG. 23.

First, in the securement processing for the billing amount and the securement processing for the tax (S805), the tax-excluded billing amount is correlated to the virtual account of the predetermined department of company B from the virtual account of company A. Meanwhile, the tax is correlated to the virtual account of the manager from the virtual account of company A.

Moreover, in the payment processing (S806), the tax included in the billed amount and managed by the manager is correlated to the virtual account of the government agency from the virtual account of the manager.

In company B, the billed amount received from company A by the specified department is remitted to the main office account, and it is possible to carry out other interchanges such as remittance of success remuneration and expenses to the predetermined department from the billed amount.

According to the billing management device 6 according to the present embodiment above, a virtual account can be easily prepared for each department, project, workplace, or position in the company, and external billing can be carried out in each unit. Moreover, since the billing in each department or the like becomes clear, it is possible to perform suitable evaluation of each department or the like, and the flow and use of funds is clear.

Furthermore, there is no loss due to nonpayment of sales receivables, and a healthy company that faithfully pays taxes can be protected.

In the above embodiment of the present invention, it is preferred that block chain technology and distributed database technology for preventing falsification and fraud be applied to the virtual currency, thereby making information management strict and allowing transaction safety to be ensured.

### REFERENCE SIGNS LIST

1 salary management device
1A salary payer information DB
1B worker information DB
1C attendance/absence information DB
1D salary information DB
1E virtual account information DB
11 salary computation unit
12 securement processing unit
13 determination processing unit
14 payment processing unit
15 communication processing unit
21 attendance/payment management device
22 salary payer terminal
23 worker terminal
24 store terminal
25 immediate settlement terminal
26 financial institution terminal
27 card manager terminal
28 financial institution terminal
3 salary management device
3A salary payer information DB
3B worker information DB
3C attendance/absence information DB
3D salary information DB
3E virtual account information DB
31 salary computation unit
32 securement processing unit
33 determination processing unit
34 payment processing unit
35 remittance processing unit
36 communication processing unit
4 salary management device
41 debit processing unit
5 salary management device
51 remittance processing unit
6 billing management device
6A company information DB
6B virtual account information DB
6C billing information DB
61 securement processing unit
62 payment processing unit
63 communication processing unit
71 company A terminal
72 company B terminal
72a main office terminal
72b department office terminal
NW network

1. A salary management device configured to be capable of communicating via a network with a salary payer terminal used by a salary payer, and
that secures, as salary, virtual currency corresponding to a labor receivable of a worker who is to receive payment of salary from the salary payer from the virtual currency held by the salary payer,
the salary management device comprising:
virtual account information storage means configured to store information pertaining to virtual accounts in which is deposited virtual currency, the virtual accounts including a virtual account held by a manager who manages salary based on labor receivables, a virtual account held by the salary payer, and a virtual account held by the worker;
attendance/absence information storage means configured to store attendance/absence information of the worker;
salary computation means configured to compute a salary amount that corresponds to the labor receivables acquired by the worker based on the attendance/absence information;
salary information storage means configured to store the salary amount that corresponds to the labor receivables acquired by the worker;
approval request transmission means configured to transmit an approval request to the salary payer terminal in relation to the salary;
approval-receiving means configured to receive approval from the salary payer terminal in relation to the salary approved by the salary payer;
first securement processing means configured to refer to the virtual account information storage means and the salary information storage means, and securing a net income amount of the worker by correlating virtual currency equivalent to the net income amount of the worker to the virtual account of the worker from the virtual account of the salary payer, in the salary that corresponds to the labor receivables acquired by the worker; and
second securement processing means configured to refer to the virtual account information storage means and the salary information storage means, and securing deductions of the worker by correlating virtual currency equivalent to the deductions of the worker to the virtual account of the manager from the virtual account of the salary payer in the salary that corresponds to the labor receivables acquired by the worker, and registering the deductions as scheduled assessment deductions in the virtual account information storage means.

2. The salary management device of claim 1, configured so as to be able to communicate via a network with an attendance/absence management device for managing attendance/absence information of the worker, and
further having attendance/absence information receiving means configured to receive attendance/absence information of the worker from the attendance/absence management device.

3. The salary management device of claim 1, configured so as to be able to communicate via a network with a worker terminal used by a worker who receives payment of a salary from the salary payer, and
further having securement processing request receiving means configured to receive, from the worker terminal, a securement processing request for salary in a range of labor receivables held by the worker.

4. The salary management device of claim 1, configured so as to be able to communicate via a network with a store terminal installed in a store where the worker purchases a product, and
further having:
settlement processing request receiving means configured to receive, from the store terminal, a settlement processing request of a price of the product purchased by the worker; and
third securement processing means configured to secure a price of the product by referring to the virtual account information storage means, correlating, to the virtual account of the manager, a portion of the virtual currency correlated to the virtual account of the worker equivalent to the price of the product, and registering said portion as a scheduled payment price.

5. The salary management device of claim 4, further having determination processing means configured to refer to the virtual account information storage means in accordance with the settlement processing request, and determining whether the price of the product is capable of being settled on the basis of the virtual currency correlated to the virtual account of the worker, and wherein
the third securement processing means
secures the price of the product by referring to the virtual account information storage means when the product price is capable of being settled,
correlates, to the virtual account of the manager, a portion of the virtual currency correlated to the virtual account of the worker equivalent to the price of the product, and
registers said portion as a scheduled payment price.

6. The salary management device of claim 5, wherein the third securement processing means divides the virtual currency registered as a scheduled payment price into a tax-excluded price and a tax, and registers the divided virtual currency.

7. The salary management device of claim 6, further having first payment processing means configured to correlate, on a predetermined date, the tax-excluded price of the product from the virtual account of the manager to a virtual account of the store.

8. The salary management device of claim 7, further having second payment processing means configured to correlate, on a predetermined date, the tax of the product from the virtual account of the manager to a virtual account of the government agency that collects the tax of the product.

9. The salary management device of claim 8, further having third payment processing means configured to correlate, on a predetermined date, the deductions from the virtual account of the manager to the virtual account of the government agency that collects the deductions.

10. The salary management device of claim 1, configured so as to be able to communicate via a network with a store terminal installed in a store where the worker purchases a product, and an instant settlement terminal for instantly settling a price based on the purchase of the product, and
further having:
instant settlement processing request receiving means configured to receive, from the instant settlement terminal, a debit processing request for the price of the product purchased by the worker;
first debit processing means configured to refer to the virtual account information storage means and debiting virtual currency equivalent to the price of the product from the virtual account of the worker; and
debit processing completion notification transmission means configured to transmit, to the instant settlement terminal, notification that debiting of virtual currency equivalent to the price has been completed.

11. The salary management device of claim 10, configured so as to be able to communicate via a network with a card manager terminal installed under a card manager for managing a prepaid card that is held by the worker and that is usable for settlement processing, and a financial institution terminal installed in a financial institution that manages an account of the card manager, and
further having:
remittance request receiving means configured to receive, from the card manager terminal which has received a charge request of a predetermined charge amount from the worker to the prepaid card, a remittance request of the predetermined amount;
second debit processing means configured to refer to the virtual account information storage means and debiting virtual currency equivalent to the predetermined charge amount from the virtual account of the worker;
remittance request transmission means configured to transmit, to the financial institution terminal, a request for remittance of virtual currency debited to the account of the card manager; and
transmission processing result transmission means configured to transmit, to the card manager terminal, the result of processing remittance of virtual currency equivalent to the predetermined charge amount.

12. A salary management device configured to be capable of communicating via a network with a salary payer terminal used by a salary payer, and
that secures, as salary, virtual currency corresponding to a labor receivable of a worker who is to receive payment of salary from the salary payer from the virtual currency held by the salary payer,
the salary management device comprising:
virtual account information storage means configured to store information pertaining to virtual accounts in which is deposited virtual currency, the virtual accounts including a virtual account held by a manager who manages salary based on labor receivables, and a virtual account held by the salary payer;
attendance/absence information storage means configured to store attendance/absence information of the worker;
salary computation means configured to compute a salary amount that corresponds to the labor receivables acquired by the worker based on the attendance/absence information;
salary information storage means configured to store the salary amount that corresponds to the labor receivables acquired by the worker;
approval request transmission means configured to transmit an approval request to the salary payer terminal in relation to the salary;
approval-receiving means configured to receive approval from the salary payer terminal in relation to the salary approved by the salary payer;
first securement processing means configured to refer to the virtual account information storage means and the salary information storage means, and securing a net income amount of the worker by correlating virtual currency equivalent to the net income amount of the worker to the virtual account of the manager from the virtual account of the salary payer, in the salary that corresponds to the labor receivables acquired by the worker; and
second securement processing means configured to refer to the virtual account information storage means and the salary information storage means, and securing deductions of the worker by correlating virtual currency equivalent to the deductions of the worker to the virtual account of the manager from the virtual account of the salary payer in the salary that corresponds to the labor receivables acquired by the worker, and registering the deductions as scheduled assessment deductions in the virtual account information storage means.

13. The salary management device of claim 12, configured so as to be able to communicate via a network with an attendance/absence management device for managing attendance/absence information of the worker, and
further having attendance/absence information receiving means configured to receive attendance/absence information of the worker from the attendance/absence management device.

14. The salary management device of claim 12, configured so as to be able to communicate via a network with a worker terminal used by a worker who receives payment of a salary from the salary payer, and
further having securement processing request receiving means configured to receive, from the worker terminal, a securement processing request for salary in a range of labor receivables held by the worker.

15. The salary management device of claim 14, further having:
remittance instruction receiving means configured to receive a remittance instruction for a predetermined amount of virtual currency from the worker terminal;
remittance processing means configured to refer to the virtual account information storage means, and correlating the predetermined amount of virtual currency to a virtual account of the worker in the virtual currency correlated as the net income amount of the worker in the virtual account of the worker.

16. The salary management device of claim 15, configured so as to be able to communicate via a network with a store terminal installed in a store where the worker purchases a product, and
further having:
first settlement processing request receiving means configured to receive, from the store terminal, a settlement processing request of a price of the product purchased by the worker, the settlement processing request being based on virtual currency correlated to the virtual account of the manager, or the settlement processing request being based on virtual currency correlated to the virtual account of the worker;
third securement processing means configured to, when the settlement processing request based on the virtual currency correlated to the virtual account of the manager has been received, secure the price of the product by referring to the virtual account information storage means, and registering, as a scheduled payment price, a portion of the virtual currency correlated as the net income amount of the worker equivalent to the price of the product, in the virtual account of the manager; and
fourth securement processing means configured to, when the settlement processing request based on the virtual currency correlated to the virtual account of the worker has been received, secure the price of the product by referring to the virtual account information storage means, correlating, to the virtual account of the manager, a portion of the virtual currency correlated to the virtual account of the worker equivalent to the price of the product, and registering said portion as the scheduled payment price.

17. The salary management device of claim 16, wherein the third securement processing means and the fourth securement processing means divide the virtual currency registered as a scheduled payment price into a tax-excluded price and a scheduled tax assessment, and register the divided virtual currency.

18. The salary management device of claim 17, further having:
first determination processing means configured to refer to the virtual account information storage means in response to a settlement processing request based on virtual currency correlated to the virtual account of the manager, and determining whether the product price can be settled based on virtual currency that is not registered as the scheduled payment price, scheduled assessment deductions, or scheduled tax assessment, in the virtual currency correlated as virtual currency of the worker in the virtual account of the manager; and
second determination processing means configured to, when a settlement processing request based on virtual currency correlated to the virtual account of the worker has been received, determine whether the product price is capable of being settled based on the virtual currency correlated to the virtual account of the worker,
the third securement processing means configured to secure the price of the product by referring to the virtual account information storage means when the product price is capable of being settled, and registering, as the scheduled payment price, a portion of the virtual currency correlated as the net income amount of the worker and equivalent to the price of the product, in the virtual account of the manager, and
the fourth securement processing means configured to secure the price of the product by referring to the virtual account information storage means when the product price is capable of being settled, correlating, to the virtual account of the manager, a portion of the virtual currency correlated to the virtual account of the worker and equivalent to the price of the product, and registering said portion as the scheduled payment price.

19. The salary management device of claim 17, further having first payment processing means configured to correlate, on a predetermined date, the tax-excluded price of the product from the virtual account of the manager to the virtual account of the store.

20. The salary management device of claim 19, further having second payment processing means configured to correlate, on a predetermined date, a tax of the product from the virtual account of the manager to the virtual account of a government agency that collects the tax of the product.

21. The salary management device of claim 20, further having third payment processing means configured to, on a predetermined payment date, pay a salary to the worker by referring to the virtual account information storage means, and correlating to the virtual account of the worker a portion of virtual currency pertaining to the salary corresponding to a labor receivable acquired by the worker, and which is not registered as a scheduled payment price, scheduled assessment deductions, or scheduled tax assessment.

22. The salary management device of claim 21, further having fourth payment processing means configured to, on a predetermined payment date, correlate the deductions to the virtual account of the government agency that collects the deductions, from the virtual account of the manager.

23. The salary management device of claim 12, configured so as to be able to communicate via a network with a store terminal installed in a store where the worker purchases a product, and an instant settlement terminal for instantly settling a price based on the purchase of the product, and
further having:
instant settlement processing request receiving means configured to receive, from the instant settlement terminal, a debit processing request for the price of the product purchased by the worker;
first debit processing means configured to refer to the virtual account information storage means and debiting virtual currency equivalent to the price of the product from the net income amount of the worker correlated to the virtual account of the manager; and
debit processing completion notification transmission means configured to transmit, to the instant settlement terminal, notification that debiting of virtual currency equivalent to the price has been completed.

24. The salary management device of claim 23, configured so as to be able to communicate via a network with a store terminal installed in a store where the worker purchases a product, and an instant settlement terminal for instantly settling a price based on the purchase of the product, and
further having:
instant settlement processing request receiving means configured to receive, from the instant settlement terminal, a debit processing request for the price of the product purchased by the worker;
second debit processing means configured to refer to the virtual account information storage means and debiting virtual currency equivalent to the price of the product from the virtual account of the worker; and
debit processing completion notification transmission means configured to transmit, to the instant settlement terminal, notification that debiting of virtual currency equivalent to the price has been completed.

25. The salary management device of claim 24, configured so as to be able to communicate via a network with a card manager terminal installed under a card manager for managing a prepaid card that is held by the worker and that is usable for settlement processing, and a financial institution terminal installed in a financial institution that manages an account of the card manager, and
further having:
remittance request receiving means configured to receive, from the card manager terminal which has received a charge request of a predetermined charge amount from the worker to the prepaid card, a remittance request of the predetermined amount;
third debit processing means configured to refer to the virtual account information storage means and debiting virtual currency equivalent to the predetermined charge amount from the net income amount of the worker correlated to the virtual account of the manager;
remittance request transmission means configured to transmit, to the financial institution terminal, a request for remittance of virtual currency debited to the account of the card manager; and
transmission processing result transmission means configured to transmit, to the card manager terminal, the result of processing remittance of virtual currency equivalent to the predetermined charge amount.

26. The salary management device of claim 24, configured so as to be able to communicate via a network with a card manager terminal installed under a card manager for managing a prepaid card that is held by the worker and that can be used for settlement processing, and a financial institution terminal installed in a financial institution that manages the an account of the card manager, and
further having:
remittance request receiving means configured to receive, from the card manager terminal which has received a charge request of a predetermined charge amount from the worker to the prepaid card, a remittance request of the predetermined amount;
third debit processing means configured to refer to the virtual account information storage means and debiting virtual currency equivalent to the predetermined charge amount from the virtual account of the worker;
remittance request transmission means configured to transmit, to the financial institution terminal, a request for remittance of virtual currency debited to the account of the card manager; and
transmission processing result transmission means configured to transmit, to the card manager terminal, the result of processing remittance of virtual currency equivalent to the predetermined charge amount.

27. A salary management method for securing, as salary, virtual currency corresponding to a labor receivable of a worker who is to receive payment of salary from a salary payer from virtual currency held by the salary payer,
by means of a computer configured to be capable of communicating via a network with a salary payer terminal used by the salary payer, wherein
the computer comprises:
virtual account information storage means configured to store information pertaining to virtual accounts in which is deposited virtual currency, the virtual accounts including a virtual account held by a manager who manages salary based on labor receivables, a virtual account held by the salary payer, and a virtual account held by the worker; and
attendance/absence information storage means configured to store attendance/absence information of the worker, and
the salary management method executes:
salary computation processing for computing a salary amount that corresponds to the labor receivables acquired by the worker based on the attendance/absence information;
processing for storing the salary amount that corresponds to the labor receivables acquired by the worker in salary information storage means;
approval request transmission processing for transmitting an approval request to the salary payer terminal in relation to the salary;
approval-receiving processing for receiving approval from the salary payer terminal in relation to the salary approved by the salary payer;
first securement processing for referring to the virtual account information storage means and the salary information storage means, and securing a net income amount of the worker by correlating virtual currency equivalent to the net income amount of the worker to the virtual account of the worker from the virtual account of the salary payer, in the salary amount that corresponds to the labor receivables acquired by the worker; and
second securement processing for referring to the virtual account information storage means and the salary information storage means, and securing deductions of the worker by correlating virtual currency equivalent to the deductions of the worker to the virtual account of the manager from the virtual account of the salary payer in the salary that corresponds to the labor receivables acquired by the worker, and registering the deductions as scheduled assessment deductions in the virtual account information storage means.

28. A computer program for causing a computer configured to be capable of communicating via a network with a salary payer terminal used by a salary payer to function as a salary management device for securing, as salary, virtual currency corresponding to a labor receivable of a worker who is to receive payment of salary from the salary payer from virtual currency held by the salary payer, wherein
the computer comprises:
virtual account information storage means configured to store information pertaining to virtual accounts in which is deposited virtual currency, the virtual accounts including a virtual account held by a manager who manages salary based on labor receivables, a virtual account held by the salary payer, and a virtual account held by the worker; and
attendance/absence information storage means configured to store attendance/absence information of the worker, and
the computer program causes the computer to execute:
salary computation processing for computing a salary amount that corresponds to the labor receivables acquired by the worker based on the attendance/absence information;
processing for storing the salary amount that corresponds to the labor receivables acquired by the worker in salary information storage means;
approval request transmission processing for transmitting an approval request to the salary payer terminal in relation to the salary;
approval-receiving processing for receiving approval from the salary payer terminal in relation to the salary by the salary payer;
first securement processing for referring to the virtual account information storage means and the salary information storage means, and securing a net income amount of the worker by correlating virtual currency equivalent to the net income amount of the worker to the virtual account of the worker from the virtual account of the salary payer, in the salary that corresponds to the labor receivables acquired by the worker; and
second securement processing for referring to the virtual account information storage means and the salary information storage means, and securing deductions of the worker by correlating virtual currency equivalent to the deductions of the worker to the virtual account of the manager from the virtual account of the salary payer in the salary that corresponds to the labor receivables acquired by the worker, and registering the deductions as scheduled assessment deductions in the virtual account information storage means.

29. A salary management method for securing, as salary, virtual currency corresponding to a labor receivable of a worker who is to receive payment of salary from a salary payer from virtual currency held by the salary payer,
by means of a computer configured to be capable of communicating via a network with a salary payer terminal used by the salary payer, wherein
the computer comprises:
virtual account information storage means configured to store information pertaining to virtual accounts in which is deposited virtual currency, the virtual accounts including a virtual account held by a manager who manages salary based on labor receivables, and a virtual account held by the salary payer; and
attendance/absence information storage means configured to store attendance/absence information of the worker,
the salary management method comprising:
salary computation processing for computing a salary amount that corresponds to the labor receivables acquired by the worker based on the attendance/absence information;
processing for storing the salary amount that corresponds to the labor receivables acquired by the worker in salary information storage means;
approval request transmission processing for transmitting an approval request to the salary payer terminal in relation to the salary;
approval-receiving processing for receiving approval from the salary payer terminal in relation to the salary approved by the salary payer;
first securement processing for referring to the virtual account information storage means and the salary information storage means, and securing a net income amount of the worker by correlating virtual currency equivalent to the net income amount of the worker to the virtual account of the manager from the virtual account of the salary payer, in the salary that corresponds to the labor receivables acquired by the worker; and
second securement processing for referring to the virtual account information storage means and the salary information storage means, and securing deductions of the worker by correlating virtual currency equivalent to the deductions of the worker to the virtual account of the manager from the virtual account of the salary payer in the salary that corresponds to the labor receivables acquired by the worker, and registering the deductions as scheduled assessment.

30. A computer program for causing a computer configured to be capable of communicating via a network with a salary payer terminal used by a salary payer to function as a salary management device for securing, as salary, virtual currency corresponding to a labor receivable of a worker who is to receive payment of salary from the salary payer from virtual currency held by the salary payer, wherein
the computer comprises:
virtual account information storage means configured to store information pertaining to virtual accounts in which is deposited virtual currency, the virtual accounts including a virtual account held by a manager who manages salary based on labor receivables, and a virtual account held by the salary payer; and
attendance/absence information storage means configured to store attendance/absence information of the worker, and
the computer program causes the computer to execute:
salary computation processing for computing a salary amount that corresponds to the labor receivables acquired by the worker based on the attendance/absence information;
processing for storing the salary amount that corresponds to the labor receivables acquired by the worker in salary information storage means;
approval request transmission processing for transmitting an approval request to the salary payer terminal in relation to the salary;
approval-receiving processing for receiving approval from the salary payer terminal in relation to the salary approved by the salary payer;
first securement processing for referring to the virtual account information storage means and the salary information storage means, and securing a net income amount of the worker by correlating virtual currency equivalent to the net income amount of the worker to the virtual account of the manager from the virtual account of the salary payer, in the salary that corresponds to the labor receivables acquired by the worker; and
second securement processing for referring to the virtual account information storage means and the salary information storage means, and securing deductions of the worker by correlating virtual currency equivalent to the deductions of the worker to the virtual account of the manager from the virtual account of the salary payer in the salary that corresponds to the labor receivables acquired by the worker, and registering the deductions as scheduled assessment deductions.
